(19) United States
(12) Patent Application Publication
(10) Pub. No.: US 2023/0259992 A1
(43) Pub. Date: Aug. 17, 2023

(54) METHODS AND SYSTEMS FOR REAL-TIME COMPOSITE PERFORMANCE SCORE ASSESSMENT FOR A SYSTEM COMPRISING LIB ASSETS

(71) Applicant: Kartik GOPAL, Bangalore (IN)

(72) Inventors: Kartik GOPAL, Bangalore (IN); Vijendra KUSHWAHA, Kanpur (IN)

(21) Appl. No.: 18/013,461

(22) PCT Filed: Mar. 4, 2021
(86) PCT No.: PCT/IN2021/050205

§ 371 Date: Dec. 28, 2022

(30) Foreign Application Priority Data
Mar. 5, 2020 (IN) 202021009534

(51) Int. Cl. G06Q 30/0282; H02J 13/00

(52) U.S. Cl. CPC G06Q 30/0282; H02J 13/00002

(57) ABSTRACT

The principal object of the embodiments herein is to disclose a systems and methods to enable stakeholders to define one or more holistic measures of composite performance score, to derive an a priori estimate of the composite performance score of the system as well as its components and stakeholders, and continuously update the same in a real-time, trusted and automated manner, by accounting for technical, operational as well as financial performance of the system elements in an automated, trusted, real-time manner. Another object of the embodiments herein is to disclose methods for predicting technical KPIs of LiBs over time for a given LiB asset for the specific operating and environmental conditions in which the battery pack is to be used in.

### CROSS REFERENCE TO RELATED APPLICATION

This application is based on and derives the benefit of Indian Provisional Application 202021009534 filed on 5 Mar. 2020, the contents of which are incorporated herein by reference.

### TECHNICAL FIELD

Embodiments disclosed herein relate to Lithium-ion batteries and Blockchain Distributed Ledger (BDL) technologies, and more particularly to defining and assessing in an automated, trusted and real-time manner, a composite performance score for a system comprising LiB assets.

### BACKGROUND

Lithium-ion batteries (LiB) are being used as energy storage devices for a variety of appliances and applications, such as, but not limited to, watches, mobile phones, laptops, Electric Vehicles (EVs), stationary energy storage, and the like. Assets containing LiBs are often deployed within an ecosystem of stakeholders, such as financial institutions financing the LiB assets, operators who use the LiB assets such as EV buses or taxis in commercial operations, infrastructure providers who install charging stations and provide recharging services for the LiB s, entities who repair and maintain the LiB assets, and regulatory bodies who oversee the policies and governance mechanisms of such operations. A financier within the ecosystem of stakeholders can face the following issues in financing the LiB assets:

1. The financier may not be able to predict longevity or performance of the LiBs or the reliability of its components precisely in the specific, intended operating environment and usage pattern of the LiB assets, thereby creating technology risks for the financier. This is due to the fact that the useful life of the LiBs in an application depends on factors such as the environmental conditions of use and on how the LiBs are used, such as operating profiles, duty cycles, charging behaviour, and the like, in addition to technology and design factors. There may be other technical performance parameters such as charging time, power output, mean-time between failures (MTBF) of various components in the LiB that may also impact operational performance of LiB assets, and thereby the ability of the asset to function effectively throughout the duration of financing provided for the asset.
2. The operations of LiB assets can involve multiple ecosystem stakeholders who are bound by complex, multiple, multi-party contractual agreements to ensure effective operations and utilization of the LiB assets. The contractual agreements can include clauses that mandate operators who operate the LiB assets to meet performance metrics, such as ensuring a minimum number of kilometers run or hours of operations each day, minimum uptime each month, adherence to specified geofences, charging the LiB assets using specific types of chargers only, and conducting routine maintenance at predefined intervals of time or usage, etc. Timely, accurate, trusted data from the multiple components involved—the LiB assets, the charging systems, repair and maintenance company servers etc. —can provide a clearer picture of the operator's competence in operating the LiB assets, adherence to the contractual obligations, system uptime, etc.
3. The contractual agreements can also include clauses that mandate financial transactions to occur between the stakeholders periodically based on fulfilment of specific conditions mentioned in the contractual agreements, which may be contested due to reasons such as lack of accurate data to measure performance of operational contractual obligations as indicated in point 2 above, resulting in issues of trust and transparency amongst the stakeholders. For example, in the case of an Electric vehicle (EV) bus operations in a city, one of the clauses in the contractual agreement between the operator and the transport authority could be that if the LiB asset, i.e., the EV bus, meets the Technical KPIs and the operator meets the Operating KPIs during a given month, then the transport authority is obligated to make payments for that month to the operator within a stipulated period of time after the end of the month. Whether such financial transactions occurred on time and in full—one of the financial performance metrics—may not be tracked transparently. As a result, the financiers funding the LiB assets may not have clarity on the financial behaviour of stakeholders who need to pay or be paid for services received. Other aspects such as bankability of the stakeholders, availability of guarantees for payments, escrow accounts, etc. can also add to the credit rating of the system.
4. Lack or early stages of resale markets for LiB assets, such as electric vehicles and an inability to predict residual value can affect financiers seeking to fund LiB assets. The financier may assume very conservative estimates of resale prices in their financing offer, resulting in higher cost of finance for users seeking to own, or lease, or rent a LiB asset. Techniques to predict residual value or resale value of a LiB asset, can help price the financing accurately and can help the financier to score how well the prediction of the resale value matched the future value realized.

Conventionally, financiers only consider financial factors indicated in point 3 above as a measure of credibility rating of a stakeholder or the system as a whole. Conventional techniques do not consider technical and operational factors the financier is exposed to in funding the LiB asset. The composite performance score of the system, which is a measure of risk to a financier, is required to account for the technical, operational and financial performance of an ecosystem of stakeholders operating LiB assets.

Two key parameters of a composite performance score are: being able to predict whether the LiB asset will last for and perform as expected for the duration of financing, for example, the duration of a loan or lease, and being able to predict resale value of the LiB asset. A financial organization, such as a bank, may wish to know the resale value at any time during the loan term, since there could be a delinquency at any time. With regards to operations, automated, real-time, and transparent methods are required for assessing whether obligations constituting the operational performance metrics are met by the operator of the LiB assets.

Current methods of managing and operating LiB assets include relying on the manufacturer of the LiB asset for technical warranties for the duration of the contract and underwriting operating and financial risks in an extremely conservative manner, while being largely unaware of whether the contractual obligations are being met in full or not. Financiers have to make decisions on financing such assets in the absence of data on such KPIs, leading to higher cost of financing as well as disputes amongst ecosystem stakeholders.

Currently, there are no avenues to enable stakeholders to define a composite performance score and assess taking into account a multitude of technical, operational and financial factors, and measure the same in a manner that is real-time, automated and trusted by all the stakeholders as a valid source of true information.

### Objects

The principal object of the embodiments herein is to disclose systems and methods to enable stakeholders to define one or more measures of a composite performance score, derive an estimate of the composite performance score of the system as well as its components and stakeholders prior to the start of real-world operations of the LiB assets, and continuously update the same in a real-time, trusted and automated manner, by accounting for technical, operational as well as financial performance of the system elements in an automated, trusted, real-time manner. The indicators of technical, operational and financial performance that can impact the composite performance score are hereafter referred to as Key Performance Indicators (KPIs). Real-world operations refers to deployment of the LiB asset in its intended application and environment, as against its usage for testing or trial purposes. Real-world operations would generally entail some form of economic value extraction from the LiB asset. In an embodiment herein, an individual purchasing and deploying a LiB asset for his/her home energy storage back-up usage would constitute real-world operations from the time the LiB asset is commissioned at his/her home to perform such energy storage back-up function as intended. In another embodiment herein, a deployment of EV buses with LiB into day-to-day operations in a city by a city bus operator would constitute real-world operations of the EV bus.

The principal object of embodiments herein is to disclose methods and systems for defining and assessing one or more composite performance scores for system comprising LiB assets and its operators, asset owners or loanees or lessees, users, beneficiaries, financiers and other stakeholders who may be involved in extracting economic or functional value from such LiB assets, wherein the composite performance score is assessed in a real-time, automated, trusted, and transparent manner, considering technical, operating, and financial metrics of performance, referred to as Key Performance Indicators or KPIs.

Another object of the embodiments herein is to disclose methods that enable flexibility in defining the performance indicators to be tracked for calculating a composite performance score as well as in defining how it is calculated.

Another object of the embodiments herein is to disclose methods that create an automated and immutable audit trail of the identity of entities who consensually selected a set of performance indicators, the definition and calculation of the performance indicators, the data and algorithms used in the calculations of the performance indicators for the entire operational history of the system described herein. The immutable audit trail can enhance the efficiency of financing such systems by financiers through the trust and automation delivered by the methods described herein, and provide accessible mechanisms for any entity that wishes to audit financial transactions and the underlying bases for the same in a system.

Another object of the embodiments herein is to disclose methods for predicting technical KPIs of LiBs over time for a given LiB asset for the specific operating and environmental conditions in which the battery pack is to be used in. The technical KPIs of LiBs can include parameters such as residual capacity over time compared to predicted or guaranteed residual capacity over the same time, internal resistance over time compared to predictions, charging time performance, mean-time between failures, or B10 life of components like motors, controllers in the asset, and the like.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the drawings, in which:

FIG. 1 illustrates a system for defining and assessing a composite performance score, in real-time and in an automated and trusted manner, according to embodiments herein.

FIG. 2A illustrates the main server, according to embodiments as disclosed herein;

FIG. 2B illustrates the memory, according to the embodiments herein;

FIG. 3 illustrates the functions and interrelationships of the system, according to embodiments herein;

FIG. 4 illustrates the initialization phase, according to embodiments herein;

FIG. 5 illustrates the operations phase, according to embodiments herein; and

FIG. 6 illustrates a method for defining and assessing a composite performance score, in real-time and in an automated and trusted manner, according to embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein achieve methods and systems for defining and assessing a composite performance scores using technical, operating, and financial performance indicators for the system comprising a plurality of LiB assets and its users, financiers and other stakeholders in a real-time, automated, trusted, and transparent manner. The composite performance score is also referred to as creditworthiness. Such stakeholders can include entities such as financial institutions financing the LiB assets, operators who use the asset for providing specific services, charging systems operators who install charging stations and provide recharging services for the LiBs, entities who repair and maintain the assets and regulatory bodies who oversee the policies and governance mechanisms of such operations. For example, the stakeholders can be public bus corporations comprising Original Equipment Manufacturers (OEMs) manufacturing electric buses with LiBs, a leasing company buying such electric buses and leasing the buses to an operator managing day-to-day functions, a charging infra company owning charging stations and providing charging services, repair and maintenance company, and municipal transport authorities that oversees the governance of such services and is responsible for making payments to the lessor, the operator, and charging solutions provider subject to contractual obligations being met.

Technical performance indicators of LiBs can include parameters such as their residual capacity over time compared to predicted or guaranteed residual capacity over the same time for a specified operating environment and operating patterns, changes in their internal resistance over time compared to predictions, charging time performance, mean-time between failures (MTBF) or B10 life of components like motors, controllers in the asset, and the like. Operating performance indicators can include parameters such as whether the distance covered or number of trips per day or week or month made by an electric vehicle containing the LiB, meets a stipulated criteria in a contractual agreement. Another measure can include, for example, whether the number of hours of back-up energy provided for a stationary energy storage system containing LiBs, meets the minimum stipulated hours of back-up as per the contract. Other examples of operating performance indicators include, but not limited to, overall uptime, conducting routine maintenance on time, and the like. Financial performance indicators measure whether timely and full payments occurred between parties as per stipulated terms in a contract, availability of bank guarantees, escrow accounts, the resale value realized in comparison to the predicted resale value at the start of operations and the like. The timely and full payments can depend on meeting technical and operating performance indicators stipulated in a contract.

Embodiments described herein enable stakeholders in the system to consensually define holistic measures of a composite performance scores of the system and the stakeholders, or combinations thereof, taking into account, the technical, operational, and financial performance indicators, measured in real-time, automated, and trusted manner. In contrast, conventionally, a composite performance score measures only a narrow set of financial parameters ignoring technical aspects, operational aspects, and financial aspects relevant with LiB assets, namely, resale value realization. In conventional techniques, the stakeholders may not be able to influence the definition of the composite performance score used by the financiers and to whom it applies. The term “stakeholders” and “collaborators” are used interchangeably hereinafter.

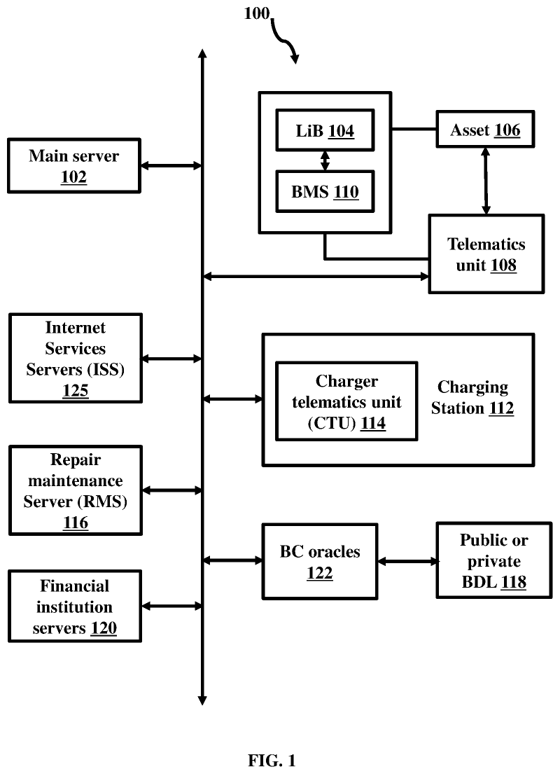

Embodiments herein estimate the residual value (RV), prior to the LiB being put to use, using data such as, but not limited to, cell level data, pack level data, vehicle characteristics, operational data, environmental data, and so on. Embodiments herein can update the initial estimate of the RV as well as initial estimates of operational and environmental conditions with real-world feedback. In an embodiment herein, the RV estimates can be updated using the data from the vehicle to validate and ‘course-correct’ the estimated RV. In an embodiment herein, the estimated values of RV and operating environments as well as aspects of the contractual agreements between stakeholders using these LiBs are encoded in a Blockchain Distributed Ledger. In an embodiment herein, the Blockchain Distributed Ledger is also periodically updated with information from the LiBs in the field as well as other ecosystem components such as charging stations, vehicles using the LiBs, financial entities making payments for use of assets, financial institutions interested to fund LiB assets, etc. Referring now to the drawings, and more particularly to FIGS. 1 through 5, where similar reference characters denote corresponding features consistently throughout the figures, there are shown embodiments.

Embodiments herein use the terms “LiB”, “battery pack”, “battery”, “pack” and so on interchangeably to refer to a Lithium-ion battery pack, wherein the battery pack can comprise one or more LiB batteries.

FIG. 1 illustrates a system 100 for defining and assessing a composite performance score using technical, operational and financial performance of the system 100 in an automated, trusted and transparent manner, according to embodiments herein. The system comprises a main server 102, a plurality of collaborators or stakeholders, and one or more Lithium-ion batteries (LiBs) 104 in one or more assets 106 to be operated in a real-world application associated with the plurality of collaborators. The system 100 comprises a plurality of technical units comprising a telematics unit (TU) 108 connected to the one or more assets 106, which can be accessed by a battery management system (BMS) 110 in the LiB 104, one or more charging stations 112, or battery swapping stations, each connected with a charger telematics unit (CTU) 114, or one or more of CTU 114 connected with a charging system servers (CSS) (not shown), a repair and maintenance server (RMS) 116, a public or private Blockchain distributed ledger (BDL) 118, financial institution servers (FIS) 120, and one or more Blockchain Oracles (BOs) 122 connected to the FIS 120, RMS 116, CSS, and BDL 118. The one or more Lithium-ion batteries (LiBs) 104 in one or more assets 106 is interchangeably referred to as plurality of LiB assets. The main server 102 comprises a memory 206, a controller 202, and an input-output interface 204. The LiB 104 can include a plurality of lithium-ion cells and a Battery management system (BMS) 110. In an embodiment herein, the one or more Blockchain Oracles 122 can be connected to hardware elements such as TU 108, BMS 110, and CTU 114. The system 100 can include servers of other collaborators or stakeholders who have contractual agreements with one or more of the other collaborators in the ecosystem. For instance, the system 100 can include servers related to regulatory bodies, such as governments, city municipality server systems, and the like. The system 100 can also include servers of internet based services, such as weather websites, foreign exchange rates, interest rates, fuel and electricity prices in various cities, second hand vehicle sales, and the like. Collectively, the internet based servers are hereinafter referred to as internet services servers (ISS 125). The main server 102 can host a set of Stakeholder User Interfaces (SUI) wherein each ecosystem stakeholder can view data and reports relevant to their roles in the ecosystem and also can input data and information relevant to their respective operations in the ecosystem. The term “server” is used broadly to include stand-alone application servers, web hosted servers on public or private cloud hosting services, distributed computing systems, or any other form of computing that offers application hosting services. The term “memory” is used broadly to include a variety of data storage methods and technologies including but not limited to RAM, ROM, SSD, hard-disks, etc.

The term “LiB asset” is used broadly to include entities that incorporate a LiB 104 as one of the components required for the functioning of the entity. In an embodiment herein, the LiB asset can be any form of an electric vehicle containing an LiB 104 (including hybrid and fuel-cell vehicles), electric aircraft and drones using a LiB 104 solely or in conjunction with other sources of energy, stationary energy storage systems for various power system applications such as power back-up, frequency regulation, load balancing, LiBs included with renewable energy systems, LiBs deployed for powering devices such as, but not limited to, consumer electronics.

The BDL 118 is a distributed ledger which is an append-only store of information, that is distributed across many computing systems. The distributed ledger is synchronized in real-time by a community of individuals or entities, sometimes known as miners or validators. A blockchain is a chain of blocks of transactions that have already been validated by a group of miners or validators. Blockchain provides a decentralized, traceable and tamper-proof record of transactions taking place between stakeholders. In a public blockchain setting, such as the Bitcoin and the Ethereum blockchain networks, all the transactions taking place on the blockchain are visible to all the stakeholders on the network. Therefore, the blockchain technology allows same-time access to the shared truth to the stakeholders, thereby creating transparency and deterring them from wrongdoings in trade and other business deals. Blockchains provide important advantages, namely, data immutability, non-repudiation, integrity, transparency, equal rights. Data immutability means that the data cannot be changed or altered after it has been created. Non-repudiation, supported by immutability, is the assurance that a party cannot deny the authenticity of their signature or a document or having sent a message or initiated a transaction. Since the data is signed and checked with cryptographic tools, data integrity is supported by default. By definition blockchains allow all users the same view of the state of the system, therefore transparency is ensured.

The public, permission-less distributed ledgers such as the Bitcoin and Ethereum blockchain systems, provide equal rights that allow every participant the same ability to access and modify the blockchain, though the rights can be weighted by compute power or the stake owned by the participant. This is in contrast with private, permission-based distributed ledger systems, where the permission for directly accessing data and for submitting transactions is limited to a list of parties. These systems are more suitable for application in enterprise settings where the participants to private distributed ledgers can join the network only after a verified and authentic invitation. The identities of the participants are known and their digital signatures or public keys are tied to the organizations they belong to, thereby establishing trust within the network. In such a setting, transparency may be reduced to allow private conversations between peers to take place, and for maintaining information confidentiality, such as vendor bids and payment details. In the embodiment herein, private and permissioned distributed ledger systems, such as Hyperledger Fabric, can be used in system 100.

Blockchain can enable high-value transactions in low trust environments. For example, Bitcoin blockchain and the other public blockchain networks have stakeholders from across the globe who are functioning in a setting where they do not trust each other. Trust in these blockchain networks comes from the interaction between the stakeholders within the blockchain network. The stakeholders rely on the network itself instead of third party organizations or services for carrying out their transactions.

According to the embodiment herein, the ecosystem can comprise multiple stakeholders or collaborators distributed geographically. The stakeholders can include, but not be limited to, individuals and organizations such as battery and electric vehicle (EV) manufacturers (OEM), charging infrastructure manufacturers and operator, EV repair and battery maintenance service providers and workers, fleet operators, vehicle drivers, project financiers, public transit regulators, banks, loan officers etc. The stakeholders may not individually trust every other participant, but may trust an ecosystem wherein data and transactions are recorded on a distributed ledger. In an embodiment herein, the fundamental means of creating trust in the system is the blockchain distributed ledger underlying data comprising technical data, operational data, and financial data gathered directly from the elements of the system using telematics units attached to the elements. The data can originate from human interventions, such as signing off on an invoice for repairs or monthly operations, the use of multisig methods to validate such information to enable traceability and trust. The distributed ledgers provide immutability, non-repudiation, integrity, and transparency of the data, i.e., the knowledge that a transaction between two or more parties cannot be rolled back, that a party cannot deny or withhold commitment to an action or process, that the data has not been tampered with, and that all parties to an agreement or transaction can witness the process in action, respectively.

Due to the limited size of the data storage and the limited amount of computation power provided by the Blockchain ledger systems, a common practice is to store the hash of the data, metadata and public or sharable data of small size on-chain. This allows the shared ledger to remain small and manageable from multiple architectural standpoints, such as permissions, security, and scalability. In the embodiment disclosed herein, the data, such as the technical, operational, and financial data, can be off-chain, i.e., present within the memory of the main server 102 and can be linked to on-chain data and metadata using a hash function. A hash function is a mathematically computed mapping or transformation from data of arbitrary size to a data of fixed size. It is a one-way function, in that it is infeasible to get back the data or any information about the data from the hash of the data. Hashing allows a dataset to be mapped to uniform sized chunks, with each chunk corresponding to only a particular dataset and that dataset alone. Further, it is computationally easy to verify the equivalence of a dataset and its hash value, hence maintaining the integrity of large datasets. The method of hashing raw data and storing this hash on the blockchain is particularly relevant for blockchain distributed ledgers where the size of a block is fixed and limited. As the transactions in the ledgers are replicated across the distributed systems, sharing hashed data in contrast to raw data, reduces the total amount of data to be stored across nodes and helps maintain the efficiency of the system. Further, easy verification of data allows maintaining integrity and other quality attributes of the system. In the embodiment disclosed, a hash function such as SHA-256, SHA-512 or any state-of-the-art hash function may be used.

The attributes provided by the blockchain distributed ledger such as the traceability, immutability and the transparency of the transactions, the decentralized or democratic system of control, along with data integrity, auditability and non-repudiation help in establishing trust between the stakeholders to enable the use of autonomous transactions. Smart Contracts are the protocols provided by the blockchain technology for enabling autonomous transactions to occur. Autonomy in transactions reduces the amount of human intervention required for the system to function smoothly and ensures that the transactions are committed to achieving their objective. According to the embodiment herein, a diverse, geographically spread out set of data sources that include LiB assets are to be accessed and processed by Blockchain elements called Smart Contracts. Smart Contracts act on data and metadata available in the Blockchain.

In an embodiment herein, the system 100 provides suitable user interfaces to enable stakeholders to select which KPIs are to be monitored and scored and define the methodology of calculating the KPIs. The selected KPIs and their calculation methodologies are encoded as smart contracts on the BDL 118. The smart contracts are executed autonomously in transactions as triggers, conditions, and business logic to enable a complex chain of transactions. The smart contracts contain predefined set of rules (agreements) according to which the stakeholders to the contract agree to interact with each other. As soon as a predefined rule in the smart contract is met, the contract then executes the protocol specified with this rule.

In an embodiment herein, the triggers could be the new events affecting the state of the blockchain, such as the injection of data coming from a measurement in the real-world operation or the associated metadata, into the storage unit of a smart contract. In the present embodiment, triggers based on metadata may include salient data points, such as numerical, categorical, etc., including, but not limited to, binary values like yes/no, timestamps, name of data source, keywords for triggering a set of specific clauses corresponding to the meeting of the predefined rule in the smart contracts, etc. Smart contracts are visible to all the stakeholders on the blockchain. Further, they are deterministic, in that they are executed as programmed, and tamper-proof, that is once they are deployed on the blockchain network usually they cannot be changed, unless endorsed by a consensus between the stakeholders. Therefore, once a Smart contract is agreed upon by the participating entities, upon deployment, the Smart contracts allow autonomous execution of a chain of transactions in a transparent, cost-effective, and secure manner. The embodiments herein disclose methods for initializing smart contracts for autonomous operation in the context of systems operating LiB assets. In an embodiment herein, the smart contract responsible for pushing the battery and operations data on the blockchain, can trigger another set of smart contracts, responsible for the calculation of the Technical Performance Score and the Operations Performance Score, to be executed.

The embodiments herein provide a way to connect real-world operations, transactions, events, and processes happening outside the blockchain, and to bring the corresponding information on the blockchain network. In an embodiment herein, the information can include, but not limited to, LiB attributes, daily operations and LiB charging data, data from charging stations and battery swaps and data about financial transactions between ecosystem stakeholders. The information can further include, not limited to, natural calamities such as earthquakes or floods etc. that might disrupt the transportation system, thereby affecting the usage patterns of the vehicle and correspondingly the LiB 104. Such information is crucial to the calculation and prediction of residual life and value of the battery, and therefore the KPI indicators of the stakeholders within the ecosystem. Data and metadata from a variety of sources including from real-world operations of system elements, tests and simulations, prior operations of similar LiB assets in other regions or ecosystems and the like, may be used in the calculation of the KPIs. The data and metadata, or their hashes are stored in the BDL 118.

A Smart contract can only examine the data and its metadata that is stored on the BDL 118. This is because any off-chain data interferes with the consensus mechanism of BDL 118. However, as explained above, external data may be required to control the execution of business logic. Therefore, to interact with the external world and to bring the external information on the blockchain network, trusted third party (TTP) services known as Blockchain Oracles (BOs) are invoked. The one or more BOs 122 are interfaces that bring off-chain data into the blockchain, that can then be used by the smart contracts for their own execution. The one or more BOs 122 are responsible for querying, verifying and authenticating their respective data about the external world. The one or more BOs 122 can invoke other Smart Contracts that they are privileged to access. As the one or more BOs 122 sign their responses with digital signatures, this provides the important requirement of non-repudiation put on the blockchain.

In an embodiment herein, the data resulting from the usage profile of the battery and the operational data of the vehicle may be written on a database of main server 102, which may then be queried by a Blockchain Oracle service using API endpoints, and a hash of this data, created by the main server 102, is injected into the storage of a smart contract in the blockchain distributed ledger BDL 118. This injection into the BDL 118 can trigger other smart contracts to fetch this data and calculate an associated KPI Score of the battery and operator. In another embodiment disclosed herein, the information about payments in fiat currency in the real world, such as, payment of portion or full amount of loan, and/or payment for services etc. taking place between ecosystem stakeholders is brought into the blockchain using the one or more BOs 122, so that an associated KPI indicators can be computed.

The one or more BOs 122 can be of type—software, hardware, human, or consensus, among others. According to embodiments herein, any one or a combination of the Blockchain Oracle types can be used. The Oracle service can be centralized or decentralized, depending on the requirements for security and reliability of the data inputs or outputs, and availability of such services. For example, according to the embodiments herein, information of disruption of transportation systems within a municipality due to a calamity or civil emergency, leading to disruption of services and thereby affecting the battery assets' and operators' performance indicators, may need to be input and verified by multiple parties at multiple levels such as vehicle operators, municipal officials, emergency services, news feeds, independent public representatives etc.

According to embodiments disclosed herein, the battery and operations data, or hash thereof, can be fetched from the main server 102 and provided to the smart contracts on the BDL 118, to trigger the Smart Contracts for calculating the Performance indicators.

In an embodiment herein, the Telematics Unit (TU) 108, the Charger Telematics Unit (CTU) 114, and the Battery Management System (BMS) 110 can act as Hardware Oracles, and can be used to push data or Hash of data into the BDL 118. As another example, a RFID tag reader at a checkpost or a toll gate, can act as a Hardware Oracle and push appropriate GPS and toll fee collection data onto the BDL 118.

According to an embodiment herein, a Human Oracle can be employed. An example of the Human Oracle, can be, but not limited to, an authorized repair and maintenance center, one of whose functions is to test the battery's performance and carry out maintenance tasks manually, and this information can be put into the blockchain. The authorized worker can enter the data into the Repair and Maintenance Server (RMS) 116 and digitally sign it off, so that the information can be available through an API endpoint and queried by another oracle service or a smart contract.

Oracles can also be categorized as whether they are inbound, that is if they bring the information from external data sources into the blockchain, or outbound, that is they bring information from the blockchain into the real world. In an embodiment herein, outbound oracle services can be used to publish essential transaction information or important notifications via third party messaging applications to the stakeholders.

According to embodiments herein, the system 100 functions in two phases: an initialization phase followed by an operations phase. The initialization phase occurs prior to the introduction of the LiB asset 106 into day-to-day real-world operations. The operations phase starts upon the introduction of the LiB asset 106 into day-to-day real-world operations.

In the initialization phase, the controller 202 can generate one or more initial blockchain smart contract codes for monitoring and calculating one or more KPIs and composite performance scores agreed upon by the plurality of collaborators, prior to the start of real-world operations. The one or more KPIs comprises one or more of the technical KPIs, one or more operational KPIs, and one or more financial KPIs. The one or more technical KPIs comprises calculating one or more of residual capacity, internal resistance or power output of the plurality of LiB assets over various points in time or after varying numbers of charge-discharge cycles and over the intended first-life and possible second-life applications of the LiB. The one or more operational KPIs comprises one or more of operating performance metrics agreed upon by the plurality of collaborators, wherein the one or more operational KPIs are tracked during operations. The one or more financial KPIs comprise one or more of timely and complete payments between the plurality of collaborators and estimates of residual value of the plurality of LiB assets at various future points in time. For generating the one or more initial blockchain smart contract codes, the controller 202 establishes connectivity amongst the plurality of technical units as required by the plurality of collaborators. The controller 202 can provide a user interface for the plurality of collaborators for defining the one or more KPIs to be measured and a method for calculating the one or more KPIs and the composite performance score. The controller 202 invokes the Smart Contract Generator Module SCGM 214 to generate the one or more initial blockchain smart contract codes based on a selection of the one or more KPIs and a method of calculating the one or more KPIs and the composite performance score, by the plurality of collaborators, and a state of agreement established by the plurality of collaborators, for each of the selected KPIs and the selected method of calculating the one or more KPIs and the composite performance score, upon authorization by the plurality of collaborators using a multisignature scheme. The controller 202 sets up the Master Contract registry during the initialization phase. The Master Contract contains the addresses of the latest smart contracts, called as Slave Contracts, corresponding to smart contract codes for calculating each KPI. The addresses provide the pointers to the Slave Contracts and a means for accessing them. The controller 202 deploys the generated one or more initial blockchain smart contract codes on the BDL 118 and records the addresses of these smart contracts in the Master Contract registry. On generating the one or more initial blockchain smart contract codes, the controller 202 performs an initial assessment of a current composite performance score, prior to the start of the real-world operations. The current composite performance score is calculated based on estimates of the one or more KPIs associated with the system 100 for one or more predefined operating patterns and environments for predefined time periods, or charge-discharge cycles, or both.

For performing the initial assessment of the current composite performance score and recording the initial assessment of the current composite performance score, on the BDL 118, the controller 202 performs a plurality of tests on the plurality of LiB assets, for collecting test data comprising cell level test data and pack level test data. The controller 202 collects and analyzes the test data and corresponding test metadata obtained from the plurality of tests and prior data and collecting and analysing estimates of operating patterns and operating environments that the plurality of LiB assets are subjected to during real-world operations and collecting and analysing estimates of financial and economic parameters that influence the residual value of the plurality of LiB assets over time. The test data can comprise one or more of HPPC and DST tests, internal resistance and temperature tests, charging, discharging, tests at the cell, pack and vehicle levels, operating patterns and operating environments data comprising routes and speed patterns including GPS data, elevation, wind speeds and directions, duty cycles, loading, ambient temperatures, and charging rates, and financial and economic parameters comprising data related to predictions of future financial and economic factors comprising one or more of interest rates, loan terms and equity to debt ratios, exchange rates, cost of capital, future prices of LiBs, fuel prices, and energy prices, impacting future value of a used LiB asset from the plurality of LiB assets.

The controller 202 stores plurality of data and one or more of results obtained from the plurality of tests and analyses and the hash of such data on the BDL 118 and a database in the memory 206. The controller 202 can calculate and record one of one or more technical KPIs and the hash of the one or more technical KPIs on the BDL 118 and a database from a plurality of databases in the memory 206. The controller 202 can initialize one or more operational KPIs and one or more financial KPIs on the BDL 118. The controller 202 calculates an initial value of the current composite performance score based on the initial values of the one or more KPIs and recording the one or more KPIs and the current composite score on the BDL 118, wherein the one or more KPIs comprises the one or more technical KPIs, the one or more operational KPIs, and the one or more financial KPIs. The controller 202 periodically collects data and corresponding metadata from the system 100 and stores the collected data, or hash of the collected data, or both, on the BDL 118. The data comprises technical data, operational data, and financial data collected during real-world operations.

In the operations phase, on storing the one or more of the collected data and hash of the collected data, the controller 202 periodically calculates and updates the one or more KPIs and the current composite performance score during the real-world operations by executing the one or more initial blockchain smart contract codes. On updating the one or more KPIs and the current composite performance score, the controller 202 generates one or more revised or updated blockchain smart contract codes for calculating one or more revised KPIs and composite performance score, selected by a plurality of collaborators during the real-world operations of the system 100. For generating the one or more revised blockchain smart contract codes, as selected by the plurality of collaborators, the controller 202 deploys the revised blockchain smart contract codes on the BDL 118 to replace one or more existing smart contracts on the BDL 118, during real-world operations, by updating a smart contract master registry. For deploying the revised blockchain smart contract codes on the BDL 118, the controller 202 provides a user interface to the plurality of collaborators for selecting one or more of revised KPIs, and revised rules for replacing the one or more of the initial KPIs and initial rules. A state of agreement is reached between the plurality of collaborators on one or more of revised KPIs and revised rules for calculating the one or more KPIs and the composite performance score, using the multisignature scheme. The controller 202 generates a smart contract for one or more of each updated KPI, the composite performance score and the revised rules for calculating the one or more KPIs and deploys the one or more generated smart contracts on the BDL 118. The controller 202 obtains the addresses of the one or more deployed revised blockchain smart contracts from the Master Contract registry and replaces the addresses of the one or more existing smart contracts in the Master Contract registry, for updating the system (100) based on the agreement between the plurality of collaborators. The controller 202 calculates the one or more revised KPIs and the current composite performance score using the data and the collected data stored in the memory 206 and the BDL 118. The controller 202 generates a report mapping the one or more KPIs and the composite performance score with the data on the BDL 118 used for the calculation of the one or more KPIs and the composite performance score, the one or more initial smart contract codes used in calculation of the one or more KPIs and the composite performance score, and the agreement agreed upon by the plurality of collaborators.

The controller 202 determines the composite performance score by invoking a plurality of modules to process the data and meta-data collected from the plurality of technical units, prior to and during real-world operations. The controller 202 updates information about the data, the corresponding metadata, and the processed data in a plurality of databases. On updating the information about the data, the controller 202 writes a hash of the updated plurality of databases on the BDL 118 and invokes one or more blockchain smart contract codes to calculate the one or more KPIs comprising technical, and operational and financial KPIs based on the processed data. On invoking the one or more blockchain smart contract codes, the controller 202 invokes a blockchain smart contract that executes the composite performance score calculation based on current technical, operational, and financial KPIs.

After the LiB 104 has been used in an electric vehicle for some time, its residual capacity may drop to such an extent that it is no longer fit for use in the EV application but is still functioning well otherwise. In such cases, the LiB 104 may be taken out of the EV and put to use in other applications, called second-life applications, where its available capacity may still be of economic value. Since the operating environment and operating patterns of a stationary energy storage application are different from that of an electric vehicle, the rate of degradation of capacity of the LiB 104 could be different in this second-life application.

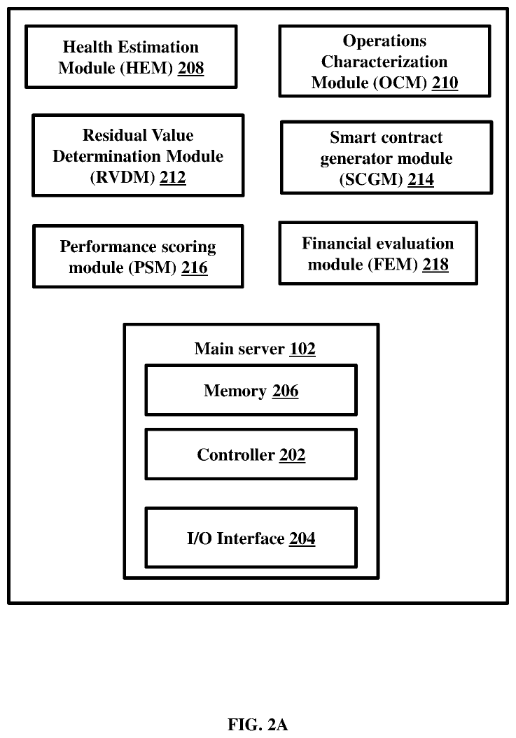

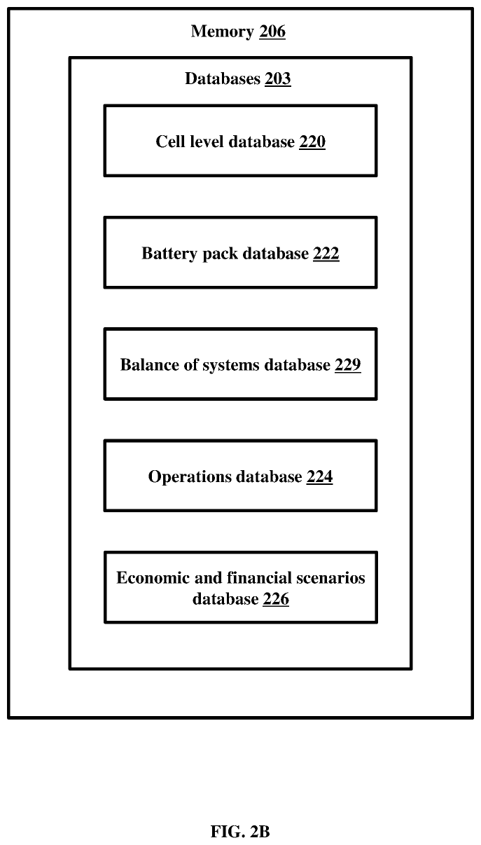

FIG. 2A illustrates the main server 102, according to the embodiments herein. The main server 102 comprises a controller 202, input-output (I/O) interface 204, and a memory 206. The memory 206, in conjunction with the controller 202, executes a plurality of modules stored in memory 206. The plurality of modules comprises a Health Estimation Module (HEM) 208, an Operations Characterisation Module (OCM) 210, a Residual Value Determination Module (RVDM) 212, a Smart Contract Generator Module (SCGM) 214, a Performance Scoring Module (PSM) 216, and a Financial Evaluation Module (FEM) 218. The main server 102 is connected through the I/O interface 204 with the BMS 124 in each LiB 104 through the TU 108 in the LiB 104, the CTU 114, and the Charger System Server (CSS), the RMS 116, FIS 120, and through the one or more BOs 122 to the BDL 118.

The OCM 210 can derive statistical inferences on the operations data present in the memory 206. For instance, given set of drive cycles data (discharging current vs time, start and end depth-of-discharge of each cycle, temperatures vs time, etc.), the OCM 210 can derive a statistical spread of discharging currents vs time, a statistical spread of depth-of-discharge at the time of starting a discharging cycle as observed from a given set of discharging data, etc. For example, the OCM 210 may derive from the drive data that 50% of the time, the current drawn from the battery pack is below a certain value, and so on. The memory 206 can comprise of such statistical characterizations of the ‘raw’ data present in the memory 206.

The HEM 208 implements cell parameter estimation and cell and pack performance and health prediction models. Cell parameter estimation can comprise estimating battery design parameters such as cell thickness and electrode porosity. The cell parameters and state of health (SOH) of the cell can be estimated by using state of the art numerical models and numerical algorithms. These models allow users to input data such as cell test data for Dynamic Stress Tests (DST) and Hybrid Pulse Power Characterisation (HPPC) tests, charge-discharge tests as well as data related to the operating and environmental conditions in which the cell is expected to be used in. The environmental data can include the annual temperature profile of the city in which the cells in the LiB are going to be used, while the operating data can include the statistical distribution of discharge currents vs time duration, charging currents vs time duration, idling periods, etc. The HEM 208 uses the data from the cell tests to estimate cell level parameters such as the anode and cathode coating thickness and porosity, open circuit voltage, etc. Using these estimations, the HEM 208 can mimic and simulate the internal behaviour of a cell when it is charged and discharged and estimate, for example, how the capacity and internal resistance of the cell will change over time. The HEM 208 fetches the testing, operating and environmental characteristics data from the memory 206 as input data and simulates the cell behaviour for the given operating and environmental conditions. The simulations mimic the real-world behaviour of the cells under similar operating and environmental conditions. The model is simulated for as many cycles of charging and discharging as desired and the model predicts the final state of health of the cell after such cycles have been run.

The HEM 208 can estimate the health of the LiB 104 over its life or over a desired set of charge-discharge cycles based on the estimates arrived at for the cell and considering the specific attributes of the battery pack stored in the memory 206. The HEM 208 comprises models of the battery pack that mimics the various structural and behavioural properties of the pack during its charging, discharging and quiescent phases and the corresponding environmental conditions in which these phases occur. The memory 206 can contain the operating conditions for each cell or group of cells or modules in the pack for a specified first-life and one or more possible second-life applications of a LiB asset. The HEM 208 can predict the life of the target cells or group of cells or modules in the pack using the cell model method or of the entire pack. In an embodiment herein, the HEM 208 derives an estimate of the changes in pack capacity over time, by iterating through the estimates of changes in cell capacity for all the cells in the pack. In an embodiment herein, the HEM 208 estimates the highest temperature reached by a cell for a given set of operating duty cycles and the thermal management algorithm stored in the memory 206 using the cell models described earlier. Based on the estimate of the degradation in health of this cell, HEM 208 applies the same degradation rate to all the cells in the entire LiB pack, thereby determining a conservative estimate of pack residual life. The HEM 208 may also use experimental test data on capacity degradation (also stored in the memory 206) of a battery pack to update or enhance its predictions.

The OCM 210 uses data from the memory 206 and/or from other sources (such as real-world operating information gathered from LiB s in the field through the I/O interface 204) to extract information relevant to residual life predictions of the LiB, reliability predictions of other components in the LiB, etc. Such information that is then stored in the memory 206. Such information can include distribution of discharging current vs time, LiB temperatures over time, charging currents over time that are estimated from data gathered from several cycles of discharging or charging, etc. as the case may be. Such information may include the operations during a specified first-life application of the LiB asset and one or more possible second-life applications for the LiB asset. The OCM 210 can include Machine Learning/Artificial-intelligence functions and other types of functions to parse the data and extract meaningful information (such as the usage scenario of a battery pack).

The RVDM 212 uses the residual life predictions from the HEM 208 and data in the memory 206. The data can be financial data and models that may affect the future price of LiBs as well as possible second-life or future uses of the LiBs to make predictions on future economic value of the battery packs that are being monitored.

For making these predictions, the RVDM 212 can use data such as relevant financial data, predictions and models that may affect the future price of LiBs, running multiple future scenarios for input variables and determining statistical estimates of future values of economic parameters of interest. The RVDM 212 can use reliability engineering techniques such as Weibull Analysis or information collected from accelerated life tests on key parts and/or other relevant techniques to estimate failure probabilities of various parts of the electric vehicle other than the battery pack based on operating and environmental conditions as well as the entire vehicle without the battery pack. The outputs of the RVDM 212 can be stored in the memory 206.

The residual value can be represented as a statistical set of values. In an embodiment herein, multiple types of residual values can be estimated as follows:
Residual value estimate of the full vehicle including the battery pack.
Residual value estimate of the vehicle without the battery pack.
Residual value estimate of the battery pack alone.

The SCGM 214 can automatically generate smart contract code that can calculate the KPIs selected by the stakeholders according to the formulae or methods also selected by the stakeholders. This encoding needs to be done once prior to the introduction of the LiB asset 106 into real-world operations and upon any changes to the selected KPIs or composite performance scores or their calculation methodologies that may be carried out by the stakeholders during real-world operations.

FIG. 2B illustrates the memory 206, according to the embodiments herein. The memory 206 comprises the following databases: Cell Level Database 220, Battery Pack Database 222, Balance-of-Systems Database XYZ, Operations Database 224, and Economic and Financial Scenarios Database 226 as well as databases containing the values of predicted and actual Technical, Operational and Financial KPIs. The hash of these databases are also stored on the BDL 118.

The cell level database 220 comprises data from tests performed on LiB cells such as Dynamic Stress Test (DST), Hybrid Pulse Power Characterisation (HPPC) tests, charge-discharge tests at various rates of charging and discharging and at different temperatures. The data are entered by one or more stakeholders. In an embodiment herein, the test results are available in a file which is then uploaded into the Cell level Database 220 by one or more stakeholders using the Stakeholders User interfaces (SUI). In an embodiment herein, data related to tests carried out on the LiB pack such as charge-discharge tests, testing and analysis of cell-to-cell deviation on temperature and voltage, thermal management system analysis, assessment of cell balancing and charging algorithms, mechanical stress tests are entered into the Battery Pack Database 222 in the memory 206 by one or more stakeholders using their respective SUI. In an embodiment herein, the battery pack data can also be entered as probability distributions of each parameter rather than deterministic values. The data from the cell level database 220 are used for performing the initial assessment of current composite performance score, prior to the start of real-world operations.

The memory 206 can comprise a Balance-of-Systems Database BSDb 229 which be initialized with data related to the expected performance of various other components of the asset 106 containing the LiBs 104. In an embodiment herein, the LiB asset 106 is an electric vehicle and the BSDb 229 contains data from reliability analysis such as Weibull analysis and reliability tests of components such as motors, motor controllers, on-board chargers, DC-DC converters, pumps and motors for air-conditioning system, etc. The Operations Database 224 comprises actual or estimated real-world data of how the LiB asset 106 is operated in the real-world in a specified first-life application and may also include such information for one or more possible second-life applications. In an embodiment herein, one or more stakeholders add data such as, but not limited to, GPS routes, speed and acceleration along the routes, operating duty cycles, charging duty cycles (information such as time of charging, charging power, start and end state-of-charge, etc.), environmental data such as ambient temperatures and weather information at the location where the LiB assets are to operate into the operations database 224 in memory 206. In an embodiment herein, the main server 102 runs an application to connect with various Internet Services Servers (ISS) through its I/O interface 204 to automatically collect and update such information periodically.

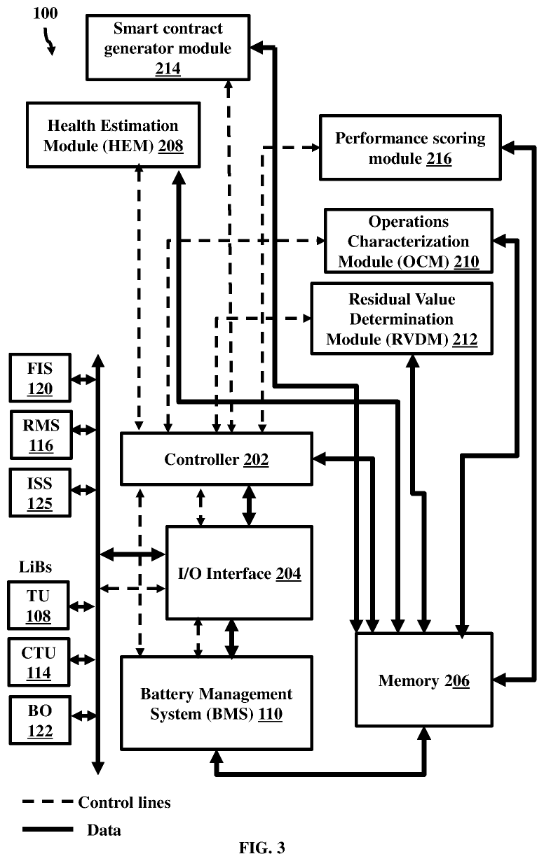

The Economic and Financial Scenarios Database (EFSDb) 226 comprises measures or projections of parameters that relate to future financial and economic scenarios that may impact the future market value of the LiB asset 106 as well as actual values observed over time of these parameters. In an embodiment herein, a financial stakeholder can enter data, such as projected future price of lithium-ion batteries, future cost of refurbishment of batteries, price of gasoline or diesel or other fossil fuels, inflation rates, interest rates, foreign exchange rates, prices of electricity, estimated prices of used LiB for resale and/or recycling, etc. In an embodiment herein, the main server 102 runs an application to connect with various Internet Services Servers (ISS) through the I/O interface 204 to automatically collect and update such information periodically. Such information can also be represented statistically in the form of probabilities. FIG. 3 illustrates the functions and interrelationships of the system 100, according to embodiments herein.

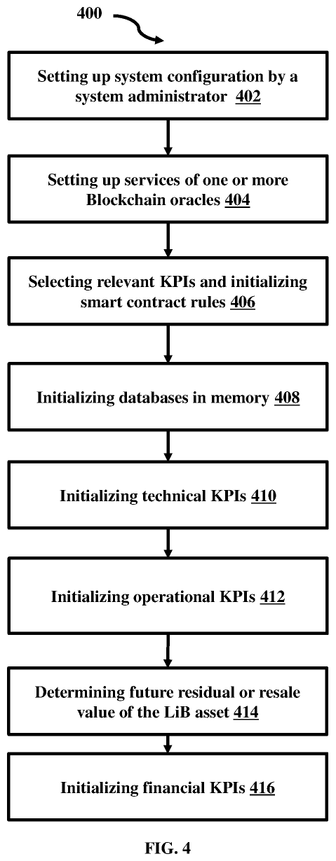

FIG. 4 illustrates the initialization phase, according to embodiments herein. In step 402, system configuration is set up by a system administrator. The system 100 comprises a plurality of components including LiB assets, charging or swapping stations, servers of stakeholder organizations, Internet Services Servers 125 (ISS), and the like, as described above. The attributes and characteristics of the system 100 and its constituents that are relevant to monitoring and determining KPIs, as well as selecting the specific KPIs to be monitored and scored, are referred to as the “system configuration”. The system configuration is defined in the main server 102 by the system administrator using the SUI or a plurality of system administrators who represent the respective stakeholders who digitally enter and sign-off on the system configuration. In an embodiment herein, the system configuration includes parameters such as the number of LiB assets and charging or swapping stations being deployed, the manufacturers and technical specifications of these LiB assets, their unique identifiers such as vehicle registration numbers in cases where the LiB asset is an electric vehicle (EV), the data being collected from these assets through the plurality of technical units comprising TU 108, CTU 114, and other sources and how the data can be used in determining the KPIs, locations of charging and swapping stations, routes on which the EV assets are to ply, identifiers such as IP addresses of the RMS 116, FIS 120, CSS (if any) and ISS 125 and connectivity to the same via APIs and the one or more BOs 122, main server 102 user identities and authentication mechanisms (who has authority to read/write data in the main server 102) and accompanying transaction rules, setting up BOs and the BDL 118. The system configuration can also include the possible second-life applications and their relevant attributes such as location, environmental conditions, operating patterns and duty cycles, “first-life residual capacity limit”—the residual capacity of the LiB 104 when the LiB 104 is taken out of the first-life application and possibly deployed into a second-life application, the “second-life residual capacity limit”—the residual capacity of the LiB 104 when the LiB 104 is taken out of the second-life application and possibly deployed into a third-life application or sent for recycling, etc. The system configuration can also include periodicity of routine repairs to be carried out, which parts, if replaced, are to be reported, whether the itemized costs of each repair and maintenance event along with dates, service personnel identifiers, location, etc. are to be reported, etc. The system configuration can also include setting up the periodicity of or triggers for collection of data from each source of data during the operations phase and the periodicity of or triggers for updating the different KPIs during the operations phase.

At step 404, services of the one or more BOs 122 are set up. Setting up Blockchain Oracle services requires steps, such as choosing the type of service—centralized or decentralized, choosing the data source nodes and their provision, interfacing the data sources with the one or more BOs 122 using web-based API endpoints, verifying and authenticating the security of the data sources and the one or more BOs 122, provisioning the one or more BOs 122 using their private cryptographic keys or digital signatures on the blockchains, creating consensus between the participants over the employment of the one or more BOs 122, setting up appropriate incentive mechanisms for rewarding the BOs 122 in return for their services etc. Setting up the Blockchain distributed ledger (BDL) 118 requires steps such as choosing a ledger system, choosing between public or private or hybrid, making decisions regarding on-chain and off-chain data, and the like.

Step 406 comprises selection of relevant KPIs and initialization of smart contract rules. The controller 202 invokes the Smart Contract Generation Module SCGM 214 to generate one or more initial blockchain smart contract codes for monitoring and calculating the one or more KPIs and composite performance score agreed upon by the plurality of stakeholders or collaborators, prior to start of real-world operations. The ecosystem stakeholders enter into one or more agreements amongst themselves, formal or otherwise, to use one or more LiB assets for specified operations for a given period of time. The one or more agreements articulate the technical and operational performance expected of the LiB asset 106 and its operators during the given period and the financial transactions to be undertaken amongst them for delivery of services using or related to the LiB asset 106. The one or more agreements may articulate dependencies amongst these KPIs, if any, such as a financial transaction is to occur only if certain operational KPIs are met, and so on. These performance parameters are henceforth referred to as Key Performance Indicators (KPIs) and are broadly classified as being Technical, Operational and Financial in nature.

In an embodiment disclosed herein, an agreement may be made between the LiB manufacturer, the electric vehicle (EV) fleet operator, and the financier of the project on the daily usage profile the LiB asset 106 will be subjected to. The agreement can include details related to, but not limited to, monitoring the following KPIs: vehicle operations to be confined to a set GPS boundary (geofence), maximum or minimum daily distance run by the vehicle, vehicle speed limits, battery charging frequency and minimum state-of-charge at which the LiB 104 should be charged, financial agreements such as payment of part of cost of LiB 104 after a predefined period of successful operations, etc. In another embodiment herein, a bank offers a loan to an individual for purchasing an electric vehicle wherein the key agreement between the bank and the loanee is for the loanee to make fixed, monthly repayments for a given period of time, wherein the monthly instalment must be paid within the first X days of the month. In this case, the system monitors only a single Financial KPI related to timely and complete repayments and there are no other technical or operational KPIs monitored.

The KPIs to be monitored and measured, each of which can correspond to one or more clauses in a legal contract or contractual agreement document, are encoded as one or more smart contracts onto a Blockchain. In an embodiment herein, the stakeholders use their respective SUIs to select or enter the agreed upon KPIs as well as any specific algorithms or formulae or methods of calculating those KPIs. Alternatively, the system 100 can offer a menu of KPI options to select from and the stakeholders can select relevant KPIs from this predefined menu of options. The calculation of KPIs can use data from multiple sources including the data being collected during real-world operations from the system elements, past data from operations, test and simulation data, etc. These data are stored in the respective databases as described earlier and the hash values of these databases are maintained in the BDL. Each KPI to be monitored is entered along with the clause number or other identifier in the contractual agreement, if any, that this KPI is referring to. In this manner, a mapping between the clauses in the contractual agreement and the KPIs being monitored is created and stored in the memory, and subsequently in the BDL 118. The frequency of calculating each KPI or the trigger to recalculate each KPI may also be chosen and recorded in the memory and the BDL.

Multisignature (multisig) is a digital signature scheme that, in this present embodiment, allows the stakeholders to the agreement to come to a consensus for deployment of the smart contract that encodes the clauses described in the contractual agreement. Multisig scheme allows multiple authorized parties with different addresses on the blockchain (implying different digital signatures or private keys) to sign off a transaction, in this case, the selection of the KPIs to be monitored is signed-off by the stakeholders using multisig scheme, creating an immutable record of which stakeholders came together and agreed on which KPIs to be monitored, at what date and time.

Upon completion of the selection of relevant KPIs and multisig sign-off by the stakeholders, the controller invokes the Smart Contract Generator Module SCGM 214 to process the KPIs recorded in memory along with any specific algorithms to be followed in calculating these KPIs, and the clause numbers in the legal contract or the contractual agreement that these KPIs refer to. The SCGM 214 generates one or more smart contract source or executable codes and these are then uploaded onto the BDL 118. On uploading the BDL 118 with the smart contracts source or executable codes, the BDL 118 can be set up with the smart contracts that can monitor and measure the KPIs agreed upon by the stakeholders in the system 100. The system 100 with the smart contracts in the BDL 118 comprises a complete audit trail that links in a transparent, immutable manner, the contractual agreements, if any, that forms the basis of the KPIs selected by the stakeholders, the identities of the stakeholders selecting the KPIs, the formulae for calculation of KPIs agreed upon by the stakeholders, the smart contract code version on the BDL that encodes the measurement, and calculation of these KPIs and the data used in the calculation of these KPIs from time to time, the hash of which is also recorded on the BDL 118.

In an embodiment herein, the stakeholders enter into a formal contractual agreement and the KPIs are required to refer to this contractual agreement. In this case, an immutable record of the entire contractual agreement may also be stored on the BDL 118 as a smart contract. To provide an authoritative validity to the smart contract, a mapping is required between the smart contract on the blockchain with the corresponding contractual agreement in the real world. In the embodiment described herein, a bidirectional binding between the smart contract and a soft copy version of a contractual agreement may be created using the following process—a smart contract is deployed on the blockchain with a variable which is initially set to blank. The deployment step provides an address for the smart contract on the blockchain. This address is then included in the soft copy of the contractual agreement. The contractual agreement is then hashed and the hash obtained is put in the smart contract variable. By having the smart contract store the hash of the contractual agreement including the address of this smart contract creates a bidirectional link between the smart contract and the contractual agreement. As the blockchain keeps track of all transactions taking place, the immutability of the legal contract or the contractual agreement is also achieved in this process, along with an authoritative mapping between the off-chain and on-chain agreements. In one of the embodiments, the contractual agreement may or may not be legally binding, depending on the requirements of the stakeholders.

In the embodiment described herein, during the real-world operations, a situation might arise where the stakeholders may want to utilize an additional data point or metadata source, not considered previously towards the calculation of a KPI or to define an additional KPI for monitoring and scoring or make changes to an existing KPI smart contract code. A method for changing or updating the terms of engagement in the contractual agreement is being described herein. Since the calculation of the KPIs and the composite performance score is performed by the execution of the smart contracts on the blockchain distributed ledger, the smart contract being a reflection of the agreed-upon requirements of the stakeholders, the changes to the terms of the agreement, either in the KPIs to be considered, or the algorithms used for measuring the metric for calculating the KPI, or the algorithm for calculating the creditworthiness score, is to be reflected in the smart contracts already deployed. Embodiments described herein disclose a method for updating the smart contracts that are already deployed and in execution on the BDL 118, with either new rules for calculating the KPIs, or for removing unnecessary rules, or for removing an unforeseen bug, in the smart contract. In an embodiment herein, the Master Contract registry contains the addresses of the latest smart contracts, called as Slave Contracts, corresponding to smart contract code for calculating each KPI. The addresses provide the pointers to smart contracts and a means for accessing them. In another embodiment, the Master Contract may also contain logic to pass data to the appropriate Slave Contract, and query and combine results produced from the execution of multiple Slave Contracts.

The stakeholders may reach an agreement to change the terms of engagement in the deployed smart contract, via the functionality provided by the SUI. Upon the request of the stakeholders, via the SUI, the SCGM 214, may generate another smart contract code reflecting the updated terms, after following the process described herein, relating to the method for reaching consensus for contractual agreement by the stakeholders in the initialization phase using the multisig scheme. The new or updated smart contract may then be deployed on the BDL 118, and the address obtained after deployment, replace the address of the old version of the smart contract in the Master Contract. This method further allows reverting to the old version of the smart contract, as per the requirement of the stakeholders. By design, the BDL 118 keeps an immutable trail of all changes made to the system 100, including the changes in contract agreement and the updation of the smart contract.

At step 408, various databases in the memory 206 are initialized by one or more stakeholders or collaborators and the hashes of these databases stored in BDL 118. The one or more collaborators use their SUIs or other suitable means to initialize available data into the databases in the memory 206. The memory 206 comprising the cell level database 220, the battery pack database 222, the operations database 224, the balance-of-systems database 229 and the economic and financial scenarios database 226 hold data related to the LiBs and its components, the operating environment and operating patterns to which the LiBs will be subjected to during operations, data related to future economic and financial factors that will impact the residual value of LiBs, etc. The stakeholders can also record metadata such as manufacturer information, batch and serial number of manufacturing, date of performing such tests, test location and equipment used, test conditions and processes, etc. in each of the above initialization operations.

The operations database 224 can comprise information similar to the “first-life operations data”, such as GPS data from prior operations of similar LiB assets, operating patterns and environmental conditions for one or more possible second-life applications to which the LiB may be put to use. Upon entry of such data into the operations database 224, the controller 202 triggers the OCM 210 to characterise the entered data and derive statistical or other inferences about the operating environment and operating patterns. In an embodiment herein, the OCM 210 may determine the statistical spread of discharge current with respect to ambient temperatures over the course of a day's operations in first-life applications and in a second-life application. Such inferences are also stored in the operations database 224 by the controller 202 possibly along with a record of the timestamps, algorithms used, etc.

In an embodiment herein, a financial stakeholder may enter data such as projected future price of lithium-ion batteries, future cost of refurbishment of batteries, price of gasoline or diesel or other fossil fuels, inflation rates, interest rates, foreign exchange rates, prices of electricity, etc. in the EFSDb 226. In an embodiment herein, the main server 102 runs an application to connect with various Internet Services Servers (ISS 125) through the I/O interface 204 to automatically collect and update such information periodically. Such information may also be represented statistically in the form of probabilities. All of this information is uploaded into the EFSDb 226.

Upon upload of data in the EFSDb 226, the controller 202 invokes the Financial Evaluation Module (FEM) 218 which then uses the data in the Economic and Financial Scenarios Database 226 to create predictions on future values of these parameters and store these back in the EFSDb 226. Such information may also be represented statistically in the form of probabilities. Each of the above databases may be hashed and stored in the BDL 118 as the initialized set of values for each of these databases.

At step 410, technical KPIs are initialized by one or more collaborators or stakeholders. Prior to the deployment of the LiB asset 106 in field operations, the stakeholders select the specific KPIs of relevance to the system as per method described earlier. Capacity (residual life) fade over the life of the LiB 104 is an important performance metric for LiBs and hence, is considered as a Default Technical KPI to be assessed. The terms “residual life”, “residual capacity” and “state-of-health (SoH)” are used interchangeably henceforth. As the LiB 104 is charged and discharged repeatedly, the LiB 104 gradually loses the amount of charge it can hold when charged fully. The rate at which this charge retention capacity decreases depends on several factors including the chemistry of the cells used, the engineering design of the LiB, operating patterns and operating environment of the LiB. In the case of an electric vehicle, the reduced capacity can impair day to day operations. For example, if an EV taxi is required to operate for at least 200 kms a day on a single charge in order to generate sustainable earnings that enables the taxi driver to repay his loans on the EV taxi, then the battery capacity of the taxi for daily operations should not fall below the capacity required to cover 200 kms in a day during the loan term.

Hence from a financier's point of view, one of the key Technical KPIs for LiBs is how well their residual capacity holds up over time (or how much it decreases with use) with a particular reference to whether it meets the operational needs of the users of the LiB for the duration of financing. If the capacity over time is not sufficient for the daily operations of the LiB asset to be operationally viable, then the risk to the financier of the asset increases. For example, if the desired daily operations require at least 80% of original capacity to be retained during the term of financing of the LiB asset, then a LiB that can retain 90% of its original capacity during that period, given the specific operating conditions of the EV taxi in that city, is considered to have a higher Technical KPI compared to another LiB that can only hold 80% after identical operations during the same term. In other words, all else being the same, the composite performance score of a LiB asset that holds 90% capacity to the end of the financing period will be rated higher than one that holds 80% capacity. The embodiments described herein establish a baseline prediction on the capacity fade of the LiB asset for the specified operations and environments which can be used by the stakeholders to assess technical risk relative to minimum expected performance for the duration of operations of interest to the stakeholders.

In an embodiment herein, the Default Technical KPI related to capacity fade characteristics may be represented as graphs of residual capacities retained vs charge-discharge cycles in first-life followed by different second-life applications, referred to henceforth as the “capacity fade graphs”. Alternatively, it may be represented by the number of charge-discharge cycles to get to a specified residual capacity in first-life applications and additional cycles that can be extracted in one or more possible second-life applications till the LiB ceases to function or till a certain even lower capacity is reached. Other Technical KPIs may include change in internal resistance over time, probability of failure over time of other components such as motors, motor controllers, chargers, etc.

An a priori estimate of the future residual capacity of the LiB 104 is a critical metric to be derived during the Initialization Phase for financing the LiB 104. The method to predict residual life and internal resistance over time of LiBs in the system comprises using cell and pack capacity prediction algorithms contained in the HEM 208 along with the data captured in the Cell level Database 220, Battery Pack Database 222, and ODb 224 to arrive at this prediction. The HEM 208 comprises algorithms which create a simulatable model of the cell and the pack using the parameters captured in or derived from the Cell level Database 220, Battery Pack Database 222 and use the operating patterns captured in the ODb 224 to simulate charge-discharge and idling cycles of the cell and battery pack models. These simulation output residual capacity and internal resistance estimates over time, among other outputs, and these may be in the form of probability distributions.

In an embodiment herein, the controller 202 invokes the HEM 208 to simulate the operating duty cycles that the LiB 104 is expected to undergo, as captured in the ODb 224, for a defined number of charge-discharge cycles and estimate the degradation in health of the cells and pack over the course of these simulated charge-discharge cycles. In another embodiment herein, the controller 202 invokes HEM 208 to simulate these operating duty cycles till the point the residual capacity reaches a predefined capacity as set by the stakeholders during initialization to estimate the number of charge-discharge cycles till such capacity is reached.

Once the simulations for the first-life application are completed up to the set point (e.g. residual capacity of 80% reached) or for a predefined number of cycles, the HEM 208 simulates one or more second-life application operating scenarios as selected by the stakeholders. In an embodiment herein, the HEM 208 assesses the amount of energy that can be extracted from the LiB 104 for the second-life applications characterised in the ODb 224, till such time that the LiB 104 reaches a predefined residual capacity or for a certain number of cycles or is no longer able to function in the second-life application.

The HEM 208 can indicate the residual capacity estimates, or the estimates of the number of cycles to get to a given residual capacity (state-of-health) within a range of values or as a probabilistic estimate with its own probability distribution type, mean, standard deviation, etc.

Further, the HEM 208 can also arrive at predictions on failure probability (Mean Time Between Failures or MTBF) or B10 life of the other components in the asset such as motor, motor controller, etc., by using reliability engineering techniques such as Weibull analysis, considering the operating patterns and environmental conditions of the asset as captured in the ODb 224 and the data captured about these components in the BSDb 229. From a financier's point of view, the failure probability of components can be taken into account while costing for the project. During the course of the project, a failure rate that is lower than the predicted failure probabilities, can be rated as having a better KPI score on this metric, and thus be translated into a higher composite performance score. Other technical KPIs can include the maximum amount of time it can take to fully charge the LiB from a completely depleted state. During the course of operations, the actual time taken to charge can be recorded, and for scoring the metric, comparing whether the actual time taken is less than, equal to or higher than the predicted time.

All these initial assessments of the Technical KPIs are stored in a Technical KPIs Database (TKPIDb) by the HEM 208 along with relevant metadata (date/time stamps, version of data used from the tables, type of algorithm or algorithms used, and so on). The controller 202 can also record this initial estimate of the Technical Performance Score as well as the hashes of the various databases on the BDL 118.

At step 412, operational KPIs are initialized by one or more stakeholders. The operational KPIs to be tracked during operations are selected or defined during the Initialization Phase by the stakeholders, and usually reflect the operating performance metrics that are agreed upon amongst stakeholders in their mutual agreements relating to the operations of the LiB assets. Examples of such KPIs can include the minimum assured uptime of an asset each month, the minimum daily assured operations of the LiB asset, the periodicity of maintenance operations to be carried out, the uptime of charging infrastructure and availability of electricity for charging, etc.

In an embodiment herein, the stakeholders may choose to define a single composite operational KPI that is derived from the weighted average of a set of metrics. For example, in an embodiment herein, the uptime of the LiB asset 106, the uptime of charging infrastructure may be assigned weightages of 60% and 40% and a composite operational KPI be defined by the weighted average scores of these two metrics. In an embodiment herein, the stakeholders may choose to define a set of independent Operating KPIs such as the uptimes of the LiB asset 106 and the charging system.

The initial scores of the defined Operational KPIs may be set to ‘unknown’ or ‘zero’ since asset operations in the field are yet to commence. If data from prior project operations about the stakeholders for similar KPIs is available, the same may be uploaded into the Operating KPIs Database (OKPIDb) by a stakeholder and digitally signed-off using multisig schemes. However, stakeholders may choose an alternative definition of such initial scores as well. These scores are stored by the Performance Scoring Module (PSM) 216 in the Operating KPIs Database (OKPIDb) and also uploaded in the BDL 118 by the main server 102 either in toto or as a hash value.

At step 414, the controller 202 determines future residual or resale value of the LiB asset 106. A financier may wish to know the expected or likely resale value (also referred to as residual value) of a LiB asset at a future point in time. This is of particular importance to a financier who is providing a loan to finance the purchase of a LiB asset, who wishes to know what is the value of the LiB asset that can be recovered if the LiB asset is repossessed due to a delinquency during the loan term. Similarly, a financier providing an operating lease on the LiB asset would need to estimate the future residual value at the end of an operating lease term.

To determine the residual or resale value, the controller 202 invokes the Residual Value Determination Module (RVDM) 212 after the cell, battery pack, operations, economic and financial scenarios databases in memory 206 have been initialized and the HEM 208 has determined the Technical KPIs including the residual capacity fade graph of the LiB 104 and failure or durability probabilities for other components. The system 100 may be configured to allow the LiB asset 106 to operate in its first-life application till a certain capacity has been reached, hereafter referred to as the “first-life residual capacity limit”, or for a certain number of charge-discharge cycles or for a certain time period or a combination thereof.

In an embodiment herein, the system configuration as setup by the stakeholders and signed-off using multisig dictates a predefined capacity or a point in time during its operations at which the LiB asset 106 is taken out of the first-life application, the “first-life residual capacity limit”, and deployed in a second-life application. The LiB 104 is then to be used in the second-life application till the “second-life residual capacity limit” is reached. These capacity limits can be entered into the system configuration during the initialization of the system configuration. The RVDM 212 then performs the following steps to assess the residual value at the end of the first-life application of the LiB 104:

a. The RVDM 212 accesses the residual capacity fade graphs that were predicted by the HEM 208 and stored in the Technical KPIs Database and determines from the graph, the number of additional charge-discharge cycles that the LiB 104 can undergo after reaching the “first-life residual capacity limit” and until a preset “second-life residual capacity limit”.
b. Given the operating duty cycles for first and selected second life applications in the ODb 224, particularly the number of charge-discharge cycles per day or over a fixed period of time, the RVDM 212 accesses the ODb 224 to determine the point in time in future when the LiB 104 will or is likely to reach the preset first-life residual capacity limit and the likely points in time when the LiB 104 will complete one or more possible second-life applications.
c. Based on the capacity fade graphs of the LiB 104 during the possible second-life applications in the TKPIDb, RVDM 212 ascertains the number of charge-discharge cycles possible during this period and the available capacity at each cycle. From these graphs, the RVDM 212 assesses the total energy extracted from the LiB 104 during the second-life application. For example, if the LiB capacity fades linearly from C1% to C2% of original capacity over X cycles during the second-life application, and the original capacity of the LiB was Y kWh, then the total energy extracted during the second-life application is calculated as: Z=[(C1%+C2%)/2*Y*X] kWh. The ODb may also contain the estimated number of charge-discharge cycles that are likely to occur in the intended first-life and second-life applications as estimated by HEM 208 as well as the estimate of number of charge-discharge cycles per unit time (such as per day or week or moth) for the first-life and second-life applications. From these parameters, the duration for which the LiB asset is used in first-life and second-life applications can be ascertained. For example, if the expected daily charge-discharge cycles is X cycles per day every day in a given second-life application, and the estimated number of charge-discharge cycles in the same second-life application is Y cycles, then the LiB asset is expected to be in second-life application for Y/(365×X) years.
d. The RVDM 212 accesses the EFSDb 226 to determine future price of electricity from the grid or other sources, future price of electricity supplied from a stationary energy storage unit, future prices of batteries, future interest rates and other financial and economic factors that can affect the future price of energy extracted from a LiB asset during the time when the LiB asset is expected to be in its second-life applications.
e. Based on the prediction of total energy drawn from the LiB in the second-life applications (step c), the point in time and duration of operations during which the LiB is predicted to be in such applications (steps a, b and c) and the price of extracted energy predicted during such time period (step d), the total market value of extracted energy during the second-life operations period is determined. For example, the price predicted for energy drawn from a stationary energy storage device is $T/kWh during the time period when the LiB is expected to be in its second-life applications, and the LiB is expected to deliver Z kWh during its second-life applications, then the market value of energy extracted during this second-life application is $R=$T*Z, extracted over the period of the LiB asset's use in the said second-life application. These values may be estimated in a probabilistic manner or as a range of values or deterministic values.
f. The RVDM 212 then calculates the net present value of $R of the calculated market value of extracted energy (step e) at the time when the LiB is taken out of the first-life application. The RVDM 212 uses interest rates and other relevant financial factors stored in the EFSDb to calculate the NPV value $R. Thus $R constitutes the residual value of the LiB at the time when it is taken out of the first-life application.

The RVDM 212 can calculate residual value for a variety of second-life applications. Further, the RVDM 212 may represent these values as a probability distribution or a range of values. These values are written into the Financial KPIs Database as one of the Financial KPIs of the system, the others being described next. The controller 202 can write these initial estimates on the BDL 118.

At step 416, financial KPIs are initialized by one or more stakeholders. The Financial KPIs can include three important categories of Metrics as follows.

The first category measures whether payments for goods delivered and services rendered occur as stipulated in the contractual agreements amongst stakeholders. The conditions to be fulfilled for such payments to occur are encoded as smart contracts on the BDL 118 at the time of initialization, as described earlier. In an embodiment herein, one of the Financial KPIs measures whether upon fulfilment of operational contractual obligations on the part of a service provider, the stipulated payment to the service provider occurred in full and within the stipulated payment window from the recipient of the services. In an embodiment herein, the LiB asset 106 is sold through a bank loan and the loanee has to make fixed repayments every month for a fixed duration of time. In this case, the Financial KPI only scores whether timely and complete payments were made by the loanee to the bank and this is not dependent on or subject to fulfilment of any other KPIs in the system 100.

Since this category of Financial KPIs will only be measured once the system 100 enters the Operations Phase, the initial values of this category of Metrics may be set to 0 in the Initialization Phase in the Financial KPIs Database by the PSM 216.

In an embodiment herein, the performance indicators of these financial transactions can result in transactions related to Escrow accounts and bank guarantees. Escrow accounts allow holding of funds until certain predefined business obligations or technical conditions have been met. The BDL 118 can include a smart contract to monitor and track KPIs (could be Technical, Operational or Financial ones) that can in turn trigger (instructions for) releasing or withholding of funds from an Escrow account or bank guarantees. Similarly, bank guarantees may also be held and released based on rules encoded in smart contracts.

In an embodiment herein, the operator deposits a surety amount into an escrow account during the Initialization Phase and agrees with a regulatory authority that a fixed portion of the amount shall be released back to the operator upon fulfilment of the Operating KPIs every year over, say 5 years. Details of such an account are uploaded in the system configuration and the FIS servers are linked to appropriate BOs 122 to monitor and trigger flow of funds. At the end of each year of operations, the escrow smart contract is triggered by the PSM 216 which checks the Operating KPIs for the past year. If these meet the minimum threshold scores, then it triggers the FIS related to the escrow account to release such funds to the operator's bank through the FIS of the operator's bank.

In an embodiment herein, the release of funds may also be done through human intervention after an instruction from a Smart Contract tracking the fulfilment of relevant KPIs for the duration of monitoring is sent to the main server 102. In this case, the Smart Contract pushes an indication of fulfilment of contractual obligations to the main server 102 which may then notify the appropriate stakeholder through the SUI or other means (email, etc.). The financier may then release the funds through a bank transaction to the intended parties. The BDL 118 has a record that the escrow smart contract did indeed detect the fulfilment of KPIs and instruct the release of funds.

The second category of Financial KPIs relate to the assessment of future Residual Value of the LiB, based on the type of operations it is expected to undergo as characterised in the ODb 224 and based on the future economic and financial scenarios stored in the Economic and Financial Scenarios Database 226, and how closely it pans out in reality in future. For this Financial KPI, the initial value is the future value assessed as per the method described earlier.

The third category of Financial KPIs relates to determining composite performance score of the system as a whole or of the stakeholders within the system. The embodiments herein enable an automated, real-time and trustworthy determination of KPIs that impact the financial bankability of the stakeholders and the technology they operate. By using one or a combination of these KPIs along with suitable weightages, a composite performance score can be derived by the PSM 216 for one or more specific stakeholders in the system, or for the system 100 as a whole.

In an embodiment herein, the Technical KPI score related to residual capacity fade, the Operational KPI score related to uptime and the Financial KPI score related to timely and complete payments between stakeholders are weighted at 30%, 40% and 30% respectively and a composite performance score is calculated by the PSM. In an embodiment herein, the financial credit rating of the payers and payees in the system is set as the initial values for the KPIs of the payers and payees. A variety of other methods can be used to calculate the composite performance score since relevant data related to technical, operational and financial performance is available in a trusted and real-time manner.

The PSM 216 updates the initialized values of these Financial KPIs in the Financial KPIs Database (FKPIDb). The controller 202 can write the initialized values of the FKPIDb or a hash of this data onto the BDL 118.

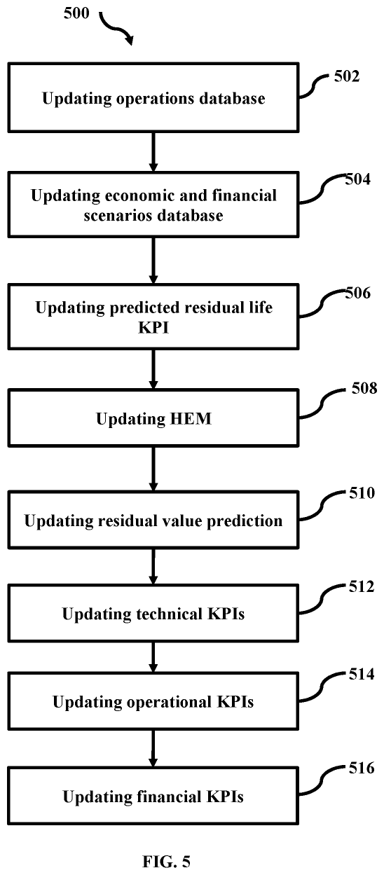

FIG. 5 illustrates the method steps involved in the operations phase, which follows the initialization phase, according to embodiments herein. Once the LiB asset 106 is deployed into real-world operations, the main server 102 and the one or more BOs 122 collect data from multiple sources such as the BMS 110 in the LiB asset 106 through the Telematics Unit (TU) 108, the Charger Telematics Unit (CTU) 114, or the Charging System Server (CSS), the Financial Institution Servers (FIS) 120, the Repair and Maintenance Servers (RMS) 116, ISS 125 and servers of other entities who may be a part of the operating ecosystem of the LiB asset 106.

In an embodiment herein, the main server 102 periodically invokes one or more of OCM 210, HEM 208, RVDM 212, FEM 218, and PSM 216 to process the incoming data, the periodicity or trigger for invocation being configured in system configuration during the initialization phase. Based on the processing outcomes of these modules, the main server 102 can update information in the respective databases and also upload a hash of the updated databases on the BDL 118.

In an embodiment herein, the one or more BOs 122 in the system 100 can also receive data from the various ecosystem entities such as BMS 110, TU 108, CTU 114, CSS, FIS 120, RMS 116, and ISS 125 which are then processed by the Smart Contracts in the BDL 118 and the outcomes thereof are uploaded onto the BDL 118 by the Smart Contract.

In yet another embodiment herein, the data from the ecosystem entities may be received both by the main server 102 and the one or more BOs 122, or only by the main server 102. The main server 102 may carry out certain pre-processing activities on the incoming data and upload the result onto the BDL 118. The upload of such pre-processed data may trigger a smart contract to carry out additional checks to determine the KPIs. For example, a smart contract may be programmed to check that the average time taken to charge a LiB 104 for all charging events in a month is not greater than, say, 4 hours. Since the average of all charging times needs to be calculated, the main server 102 may fetch the last month's data from its memory and calculate the average, and upload only the calculated average value into the BDL 118. This event then triggers a smart contract to check whether the average value reported by the main server 102 is less than 4 hours or not, and takes appropriate actions accordingly to update the relevant KPI score.

At step 502, the controller 202 updates the operations database 224. During operations, incoming data into the main server 102 from the BMS 110, TU 108, CTU 114, or CSS, RMS 116, and ISS 125 would include data related to the operations of the LiB asset 106 such as GPS information, repairs and maintenance operations conducted, charging event information and information from the LiB related to battery parameters such as voltage, currents and battery temperatures. This data is stored in the memory 206.

Upon receipt of such data, the controller 202 triggers the OCM 210 to process this data and update the contents of the ODb 224. The OCM 210 may use past data and the newly received data to draw relevant statistical inferences related to the operations of the LiB asset 106 and update the ODb 224 with the same.

In an embodiment herein, data received in the memory 206 for a given period includes the routes and speed profiles of an EV bus that is serving as the LiB asset 106 during the given period, the kilometers run during a given period, the state-of-charge at the end of each day's operations, the time taken to complete charging on each day of operations, the maintenance activities carried out during this time period as received from the RMS 116, environmental conditions during this time period as received from the ISS 125, etc. The OCM 210 uses this data to update similar data stored in the memory 206, calculate statistical values (means, modes, medians, etc.) related to operations and environmental conditions, flags any significant deviations from the currently stored profiles, and updates any statistical inferences derived from such data. All such data calculated by the OCM 210 is updated in the ODb 224.

An embodiment disclosed herein involves battery swapping station operations. The information about the state of charge of the battery that is swapped and being swapped with, is put on the BDL 118 between the TUs 108 in the LiBs 104 and the CTUs 114 or CSS of the battery swap stations. The information related to the process/event of swapping and other manual operations in the process, may require authorized access. Further, there may be personnel involved who are responsible for overseeing the operation. This set of information living in the real-world may be put on the BDL 118 using the combination of human, hardware and software blockchain oracles. All the participants in the process may be required to digitally sign off the event on completion.

Electric Charging Stations (ECS) are another application of Oracles. During the charging process, the electric charger continuously communicates with the Battery Management System (BMS) 110 of the LiB 104, using OEM specified protocols. This allows the electric charger to collect or calculate appropriate data points about the battery, such as current, state-of-charge, voltages, temperatures, etc. One or more of the battery information may be communicated to the BDL 118 via the Oracle service managed and run by the ECS using the CTU 114 or sent by the ECS to a Charging System Server (CSS) via standard protocols such as Open Charge Point Protocol (OCPP). The CSS may host a software API so that the associated BO 122 can query such data from the CSS. The information before being sent to the BDL 118 may be signed digitally by the charger or the CSS and correspondingly by the ECS. This setup therefore acts as a hardware oracle coupled with a software oracle.

In an embodiment herein, each such operation described above for battery swap stations and charging stations may be recorded on the ODb 224 in the main server 102, and a hash of this data uploaded into the BDL 118.

In an embodiment herein, the LiB asset 106 may undergo periodic maintenance or on-demand repairs during operations. Based on the settings in the system configuration, certain information may be collected from the repair and maintenance servers and uploaded into the ODb 224 from the RMS 116 and the same may also be uploaded onto the BDL 118 through the one or more BOs 122 and also received in the memory 206 of the main server 102, processed by OCM 210 and updated in the ODb 224.

Upon update of the ODb 224, the controller 202 can calculate the hash of the received data and can write the calculated hash in the BDL 118.

At step 504, the economic and financial scenarios database 226 is updated by the controller 202. In an embodiment herein, the main server 102 can poll for and receive from various Internet Services Servers (ISS 125), automatic periodic updates to the values stored in the EFSDb 226 through the I/O interface 204. These values can refer to future predictions of parameters being recorded in the EFSDb and actual values as on date. Whenever such an update is received in memory 206, the controller 202 triggers the FEM 218 to re-evaluate and update the predictions related to economic and financial factors as currently stored in the EFSDb 226. For example, upon interest rate changes in the market or receipt of resale prices of similar LiB assets sold in the second-hand market, updated information may be received from an ISS 125. The FEM 218 may re-evaluate and update its predicted future interest rate in the EFSDb 226 and subsequently a hash of the relevant data in the EFSDb 226 can be updated in the BDL 118.

At step 506, the predicted residual life KPI is updated by the controller 202. The controller 202 invokes the HEM 208 to reassess the predicted residual life of the LiB assets 106 either at a preset periodicity or upon a milestone such as a periodic capacity check being undertaken at the repair and maintenance centre or upon the updates to the ODb 224 or any other triggers that may be preset in the system configuration. If the ODb 224 has been updated, then the controller 202 invokes the HEM 208 to reassess the residual capacity fade graph of the LiB 104 using the updated operations data in the ODb 224. In an embodiment herein, the HEM 208 periodically simulates the capacity fade using the recorded real-life operations data in the ODb 224 and generates an updated residual capacity fade graph. The same is updated in the TKPIDb. In an embodiment herein, if a test result from a capacity test conducted at the repair and maintenance centre has been received by the main server 102, then the controller 202 invokes the HEM 208 to compare the test results with the results predicted by the HEM 208 as stored in the TKPIDb and update the future predictions of the residual life i.e. the residual capacity fade graph recorded in the TKPIDb. The controller 202 can also hash the relevant data in the TKPIDb database and update the BDL 118 with the new residual value prediction graph.

At step 508, the controller 202 updates the HEM 208. Whenever the RMS 116 provides a measurement of residual capacity based on a test carried out at the repair and maintenance center, the controller 202 invokes the HEM 208 which compares the measured residual capacity against the predicted capacity in the Initialization Phase as stored in the Technical KPIs Database as well as the other predictions made during the Operations Phase that might have used the actual operating data from the field as stored in the Odb 224. If the actual capacity is different from any of these predictions, then the HEM 208 may need to update its algorithms to improve its predictions. The HEM 208 can invoke a variety of machine learning and other techniques to improve its prediction algorithms. These improved algorithms can be stored in the TKPIDb and a hash of relevant data in the updated database can also be published on the BDL 118 by the controller 202.

At step 510, the residual value prediction is updated by the controller 202. The controller 202 invokes the RVDM 212 to reassess the predicted residual values of the LiB assets either at a preset periodicity or upon a milestone such as a periodic capacity check being undertaken at the repair and maintenance centre or upon the updates to the ODb 224 or the ESFDb 226 or any other triggers that may be preset in the system configuration. If the ODb 224 has been updated or a test result from a capacity test conducted at the repair and maintenance centre has been received, then the controller 202 invokes the HEM 208 to reassess the residual capacity fade graph of the LiB 104. Upon completion of residual capacity fade graph update or upon an update to the EFSDb 226 or upon the occurrence of any other predefined trigger, the controller 202 invokes the RVDM 212 to reassess the residual value prediction based on changed economic conditions as captured in the EFSDb 226. The RVDM 212 uses the updated residual capacity fade graph and values in the EFSDb 226 to reassess the future residual value as per method described earlier. The updated residual value prediction is stored in the FKPIDb. The controller 202 can hash relevant data of this database and update the BDL 118 with the new residual value prediction.

At step 512, the controller 202 updates the technical performance indicators. A default Technical KPI is the residual capacity fade performance of the LiB 104. The score of this default Technical KPI can be updated by the PSM 216 based on the data received from field operations by the controller 202. In an embodiment herein, whenever a capacity measurement test is conducted by a repair and maintenance centre, the measured capacity is uploaded into the RMS server 116 and signed-off digitally by the stakeholders, the same is received in the memory 206 through the I/O interface 204. The controller 202 triggers the HEM 208 and RVDM 212 to conduct their respective analyses as described earlier. The controller 202 also triggers the Performance Scoring Module (PSM) 216 to check whether the measured residual capacity is greater than, equal to or less than the predicted residual capacity at this point in the operations of the LiB 104 and as stored in the TKPIDb.

In an embodiment herein, the PSM calculates the Technical Performance Score, as shown below:

Measured Capacity at time t1: MC1
Predicted Capacity at time t1: PC1

Technical Performance Score for residual capacity prediction=1−[(MC1−PC1)/PC1] in %

The calculated Technical Performance Score is updated into the TKPIDb along with metadata such as timestamps, algorithm version used, etc. The hash of this updated TKPIDb can be uploaded by the controller 202 into the BDL 118.

In an embodiment herein, a smart contract programmed to calculate this score is invoked whenever the relevant BO collects residual capacity measurement data from the RMS 116 and injects the data into the storage of the smart contract. The smart contract executes the comparison algorithm between measured and predicted capacities and records the score in the BDL 118.

In an embodiment herein, some of the calculation may be carried out by the PSM 216 and uploaded into the BDL 118, along with a trigger to a smart contract to process this uploaded data further. The smart contract then completes the processing of the score and updates the score on the BDL 118 and can push the same back to the main server 102, to be updated in the TKPIDb.

Other performance metrics can be defined, such as the predictions on MTBF or B10 life of components, deviation of measured and actual internal resistance, charging performance, etc. Each such Performance Score is calculated by the PSM 216 as per algorithms agreed upon during the Initialization Phase of the system and records these in the memory 206 and can also be calculated on a smart contract in the BDL 118. In an embodiment herein, the calculation of the MTBF or B10 life or internal resistance score uses an algorithm similar to the calculation of residual capacity score, wherein the RMS 116 publishes data on part failures and the same is uploaded to the BDL 118 and main server 102 and the actual time of failure is compared with the predicted time of failure. If the part lasts longer than predicted, it has a positive higher score. In an embodiment herein, the calculation of the part failure prediction Technical KPI Score on the BDL 118 using a Smart Contract includes data of all failures of the part from all the LiB assets in operation in the system 100.

At step 514, operational performance indicators are updated by the controller 202.

Operational Performance indicators can include metrics such as the uptime of the asset over a given period as compared to the target minimum uptime of the LiB asset 106 and of the charging or battery swapping systems, the daily distance covered or hours operated by a LiB asset compared to the minimum or maximum it should carry out as stipulated in an agreement amongst stakeholders, keeping the state-of-charge above a minimum level always, operating the LiB asset within a defined geo-fence, etc.

The set of Operational KPIs to be calculated are agreed upon amongst stakeholders at the time of system configuration during the Initialization Phase. The stakeholders also agree upon the periodicity or trigger for updating the Operational KPIs. For example, the uptime may be calculated and updated on a monthly basis while daily distance covered on a daily basis.

The data required to measure and calculate these KPIs is collected during the system operations in the Operational Phase from the various entities in the system including the TU 108, CTU 114, CSS, BMS 110, etc. In an embodiment herein, the data so collected is stored in the ODb 224 in the memory 206 of the main server 102 and a hash of such data is periodically uploaded into the BDL 118. In an embodiment herein, the main server 102 invokes the PSM 216 to calculate and update the score as per the agreed upon periodicity or trigger. The PSM 216 calculates the hash of the operations data (such as GPS coordinates, speed of vehicle, battery data during the trip like current, voltage and temperature) and puts it on the blockchain, along with the associated metadata. The injection of data into the blockchain may trigger another set of smart contracts that initiate a cascade of transactions. Since all these operations can happen autonomously without any human intervention and can be seen to be happening on the blockchain by any participant of the ecosystem, this helps establish transparency in the process and thereby trust between stakeholders.

At step 516, the controller 202 updates the financial performance indicators. Financial Performance indicators can include at least three categories of indicators—first, whether the agreed upon payments between stakeholders occurred as per agreement terms, second, how well does the residual or resale value of the LiB asset 106 realized in the market compare with the predicted resale value, and third, the composite performance score of the stakeholders or the system as a whole.

In an embodiment disclosed herein, settlement of payments occurs between stakeholders using fiat currency but the process of initiating invoices for payments and records of payments are recorded on the BDL 118 using smart contracts. Fiat currency is a legal tender whose value is backed by the government that issued it. Initially, a payee stakeholder creates an invoice using a BO service to invoke a smart contract that sends a notification to the payer (the one who has to make the payment) informing them of the payment due. The process of sending notification involves the use of a service called an outbound oracle, whose function is to bring information from the smart contract on the BDL 118 to the outside world. Then the payer, upon transferring the payment, uses an Oracle service to invoke a smart contract that informs the blockchain network of the payment done. This invokes another smart contract whose function is to request information from another Oracle service to query the bank API hosted by the Financial Institutions Server FIS 120, using appropriate credentials. This Oracle service can ascertain information as to whether a payment has actually been done by a party or not, and invoke another Smart Contracts, the execution of which leads to writing of the confirmation of receipt of payment in the blockchain, hence completing the process of offline payment and placing the records on the BDL 118.

Each time such an invoice is raised and payments are made (or not), the FPS is tracking whether the invoices raised and payments made are as per agreements encoded in a smart contract. By calculating the Financial KPI Score related to compliance (or lack thereof) to agreed payment terms and recording the same, these smart contracts enable trust and transparency related to payments in the system. In an embodiment herein, the Financial KPI Score related to timely and complete payments, when the pre-conditions are met, is calculated as follows:

The payments linked Financial KPI Score is initialized to a value of 100%. For each week of delay in payment, the payments linked Financial KPI Score is reduced by X % and for each instance of partial payments, it is reduced by Y % percentage.

In an embodiment herein, the Financial KPI Score related to resale value is calculated based on the difference between realized resale value and predicted resale value, as a percentage of the predicted resale value. A higher score indicates a better-than-predicted value was realized, a negative value indicates the value realized was lower than predicted. The actual resale value realized may be entered into the main server 102 by a stakeholder using her SUI or collected from one or more ISS 125 servers that track the resale market by the main servers 102. The realized resale value may reflect the average or some statistical measure of resale value realized across more than one LiB asset 106 sold in the market.

In an embodiment herein, the PSM 216 calculates a composite performance score of the entire system including the LiB assets and the key ecosystem stakeholders. This may be calculated using a variety of algorithms. One embodiment of such an algorithm is for a smart contract in the BDL 118 to calculate the composite performance score as a weighted average of the Technical, Performance and Operational indicators, wherein the weights are assigned by a mutual consensus amongst the stakeholders at the time of system configuration setting in the Initialization Phase. The composite performance score is published on the BDL 118 ensuring a real-time, automated, transparent method of calculation.

Such a composite performance score may then be used by financial institutions to fund future projects of the same set of stakeholders. An example of such a situation could be that in a system where the LiB asset is an EV bus being used for public transport operations in a city, the LiB in the EV bus may need to be replaced after a few years of operations. The financiers can then use the composite performance score of the system at the time of replacement of the LiB, to provide funding for the new (replacement) LiB on financial terms that reflect the composite performance score of the system.

In addition to the three types of KPIs described, the PSM 216 may also calculate other types of financial performance indicators. In an embodiment herein, the PSM 216 calculates such Financial Performance indicators and updates the same in the BDL 118. In another embodiment, the PSM 216 can share the data or the hash of the relevant data to a smart contract in the BDL 118, which can then calculate the Financial Performance Score and update the same in the BDL 118.

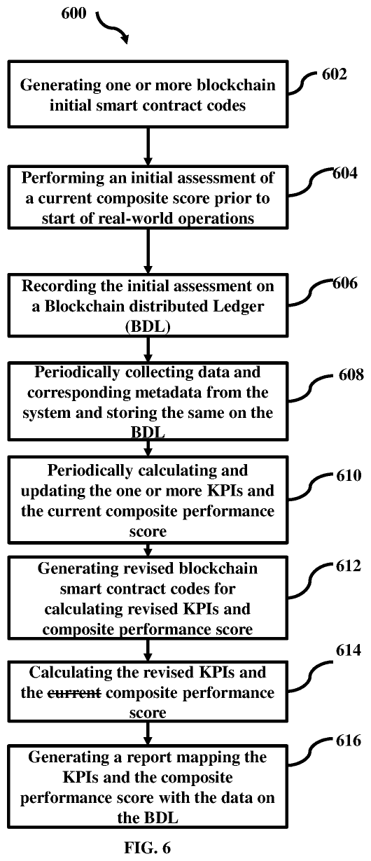

FIG. 6 illustrates the method for determining a composite performance score, in real-time and in an automated and trusted manner, for the system 100, according to the embodiments herein. The method involves the initialization phase and an operations phase as described above. At step 602, the controller 202 generates one or more blockchain initial smart contract codes for monitoring and calculating one or more KPIs and composite performance scores agreed upon by the plurality of collaborators, prior to start of real-world operations. The one or more KPIs comprises one or more of the technical KPIs, one or more operational KPIs, and one or more financial KPIs. The one or more technical KPIs comprises calculating one or more of residual capacity, internal resistance or power output of the plurality of LiB assets over various points in time or after varying numbers of charge-discharge cycles and over the intended first-life and possible second-life applications of the LiB. The one or more operational KPIs comprises one or more of operating performance metrics agreed upon by the plurality of collaborators, wherein the one or more operational KPIs are tracked during operations. The one or more financial KPIs comprise one or more of timely and complete payments between the plurality of collaborators and estimates of residual value of the plurality of LiB assets at various future points in time. At step 604, on generating the one or more initial blockchain smart contract codes, the controller 202 performs an initial assessment of a current composite performance score, prior to the start of the real-world operations. The current composite performance score is calculated based on estimates of the one or more KPIs associated with the system 100 for one or more pre-defined operating patterns and environments for a pre-defined time, or charge-discharge cycles, or both.

At step 606, the controller 202 records the initial assessment of the one or more KPIs and current composite performance score on a blockchain distributed ledger (BDL) 118. At step 608, the controller 202 periodically collects data and corresponding metadata from the system 100 and stores the collected data, or hash of the collected data, or both, on the BDL 118. The data comprises technical data, operational data, and financial data collected during real-world operations.

In the operations phase, at step 610, on storing the one or more of the collected data and hash of the collected data, the controller 202 periodically calculates and updates the one or more KPIs and the current composite performance score during the real-world operations by executing the one or more initial blockchain smart contract codes. At step 612, on updating the one or more KPIs and the current composite performance score, the controller 202 generates one or more revised or updated blockchain smart contract codes for calculating one or more revised KPIs and composite performance score, selected by a plurality of collaborators during the real-world operations of the system 100. At step 614, the controller 202 calculates the one or more revised KPIs and the current composite performance score using the data and the collected data stored in the memory 206 and the BDL 118. At step 616, the controller 202 generates a report mapping the one or more KPIs and the composite performance score with the data on the BDL 118 used for the calculation of the one or more KPIs and the composite performance score, the one or more initial smart contract codes used in calculation of the one or more KPIs and the composite performance score, and the agreement agreed upon by the plurality of collaborators.

An advantage of using Blockchains, Smart Contracts and Oracles is the automatic availability of their execution logs, which can be used to create audit trails, allowing automated and real-time audits. Further, as the blockchains provide immutability of data and the transactions, the audit trails so created are immune to adversary attacks. In case of any dispute, log files of Smart Contracts and Blockchain Oracles can be used to ascertain the sequence of operations performed and understand the root cause of a discrepancy in the disputed event or process.

The various actions in methods 400, 500, and 600 may be performed in the order presented, in a different order or simultaneously. Further, in some embodiments, some actions listed in FIGS. 4, 5, and 6 may be omitted.

The embodiments disclosed herein can be implemented through at least one software program running on at least one hardware device and performing network management functions to control the network elements. The elements shown in FIGS. 1, 2A, 2B, and 3 include blocks which can be at least one of a hardware device or a combination of hardware device and software module.

The embodiment disclosed herein describes methods and system for determining a composite performance score, in real-time and in an automated and trusted manner, the system comprising a plurality of LiB assets, a plurality of collaborators, and a plurality of technical units associated with the plurality of LiB assets. The methods and system estimate the RV of the LiBs, developing credit risk estimates and associated financial instruments and evaluating performance of contractual obligations using Blockchain smart contracts and using Blockchain as a basis for fund raising for projects. The LiB could conform to any specific type of chemistry of cathode, anode or electrolyte and be in any shape or form or structure whatsoever. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in a combination of one or more languages and frameworks such as C, C++, Java, Julia, Python, R, DAML smart contract language, etc. or several software modules being executed on at least one hardware device. The hardware device can be any kind of portable or non-portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs and a single or plurality of databases.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

I/We claim:

1. A method for determining a composite performance score, in real-time and in an automated and trusted manner, for a system (100) comprising a plurality of LiB assets, a plurality of collaborators, and a plurality of technical units associated with the plurality of LiB assets, the method comprising:
generating, by a controller (202), one or more initial blockchain smart contract codes for monitoring and calculating one or more Key Performance Indicators (KPIs) and composite performance score agreed upon by the plurality of collaborators, prior to start of real-world operations;
performing, by the controller (202), an initial assessment of a current composite performance score, prior to the start of real-world operations, wherein the current composite performance score is calculated based on estimates of the one or more KPIs associated with the system (100), for one or more predefined operating patterns and environments for one or more of predefined time periods and charge-discharge cycles;
recording, by the controller (202), the initial assessment of the one or more KPIs and current composite performance score on a blockchain distributed ledger (BDL) (118);
collecting, by the controller (202), periodically, data and corresponding metadata from the system (100);
storing, by the controller (202), one or more of the collected data and hash of the collected data on memory (206) and the BDL (118);
calculating, by the controller (202), periodically, and updating the one or more KPIs and the current composite performance score during the real-world operations by executing the one or more initial blockchain smart contract codes;
generating, by the controller (202), one or more revised blockchain smart contract codes for calculating one or more revised KPIs or the composite performance score, selected by the plurality of collaborators, wherein the revised blockchain smart contract codes are generated by revising the one or more initial blockchain smart contract codes during real-world operations of the system (100);
calculating, by the controller (202), the one or more revised KPIs and the current composite performance score using the collected data stored in memory (206) and the BDL (118); and
generating, by the controller (202), a report mapping the one or more revised KPIs and the composite performance score with the data on the BDL (118) used for the calculation of the one or more KPIs and the composite performance score, the one or more initial blockchain smart contract codes used in calculation of the one or more KPIs and the composite performance score, and an agreement agreed upon by the plurality of collaborators prior to the start of real-world operations.

2. The method as claimed in claim 1, wherein the data comprises one or more of technical data, operational data, and financial data collected during real-world operations.

3. The method as claimed in claim 1, wherein generating, by the controller (202), the one or more initial blockchain smart contract codes, comprises:
establishing connectivity amongst the plurality of technical units as required by the plurality of collaborators;
providing a user interface for the plurality of collaborators for defining the one or more KPIs to be measured and a method for calculating the one or more KPIs and the composite performance score;
generating the one or more initial blockchain smart contract codes based on a selection of the one or more KPIs and the method of calculating the one or more KPIs and the composite performance score, by the plurality of collaborators, and a state of agreement established by the plurality of collaborators, for each of selected one or more KPIs and selected method of calculating the one or more KPIs and the composite performance score, upon authorization by the plurality of collaborators using a multisignature scheme; and
deploying the generated one or more initial blockchain smart contract codes on the BDL (118).

4. The method as claimed in claim 1, wherein performing the initial assessment of the current composite performance score, prior to the start of real-world operations and recording the initial assessment of the current composite performance score, on the BDL (118), comprises:
performing a plurality of tests on the plurality of LiB assets, for collecting test data comprising cell level test data and pack level test data;
collecting and analysing the test data and the collected data and corresponding test metadata obtained from the plurality of tests and prior data and collecting and analysing estimates of operating patterns and operating environments that the plurality of LiB assets is subjected to during real-world operations and collecting and analysing estimates of financial and economic parameters that influence a residual value of the plurality of LiB assets over time;
storing test plurality of data and analysing one or more of results obtained from the plurality of tests and analyses and the hash of the test such data on the BDL (118) and a database in the memory (206);
calculating and recording one of one or more technical KPIs and the hash of the one or more technical KPIs on the BDL (118) and a database from a plurality of databases in the memory (206);
initializing one or more operational KPIs and one or more financial KPIs on the BDL (118); and
calculating an initial value of the current composite performance score based on initial values of the one or more KPIs and recording the one or more KPIs and the current composite performance score on the BDL (118), wherein the one or more KPIs comprises the one or more technical KPIs, the one or more operational KPIs, and the one or more financial KPIs.

5. The method as claimed in claim 4, wherein the test data comprises data related to operations and operating environment of the plurality of LiBs during intended first-life and future second-life applications, the data comprising one or more of HPPC and DST tests, internal resistance and temperature tests, charging, discharging, idling profiles tests at the cell, pack and vehicle levels, operating patterns and operating environments data comprising routes and speed patterns, elevation, wind speeds and directions, duty cycles, loading, ambient temperatures, and charging rates, and financial and economic parameters comprising data related to predictions of future financial and economic factors comprising one or more of interest rates, loan terms and equity to debt ratios, exchange rates, cost of capital, future prices of LiBs, fuel prices, and energy prices, impacting future value of a used LiB asset from the plurality of LiB assets.

6. The method as claimed in claim 1, wherein, on generating the one or more revised blockchain smart contract codes, as selected by the plurality of collaborators, the method comprises deploying, by the controller (202), the revised blockchain smart contract codes on the BDL (118) to replace one or more existing smart contracts on the BDL (118), during real-world operations, by updating a smart contract master registry.

7. The method as claimed in claim 5, wherein, deploying the revised blockchain smart contract codes on the BDL (118) comprises:
providing, by the controller (202), a user interface to the plurality of collaborators for selecting or defining one or more of revised KPIs, and revised rules for replacing the one or more of the initial values of the one or more KPIs and initial rules;
reaching a state of agreement between the plurality of collaborators on one or more of revised KPIs and revised rules for calculating the one or more KPIs and the composite performance score, using a multisignature scheme;
generating, by the controller (202), a smart contract for one or more of each updated KPI, the composite performance score, and the revised rules for calculating the one or more KPIs, and deploying the one or more generated smart contracts on the BDL; and
obtaining addresses of the one or more deployed revised blockchain smart contracts, and replacing the addresses of the one or more existing smart contracts in a master registry, for updating the system (100) based on the agreement between the plurality of collaborators.

8. The method as claimed in claim 1, wherein the one or more KPIs comprises one or more technical KPIs, one or more operational KPIs, and one or more financial KPIs.

9. The method as claimed in claim 8, wherein the one or more technical KPIs comprises calculating one or more of residual capacity, internal resistance or power output of the plurality of LiB assets over various points in time or after varying numbers of charge-discharge cycles and over intended first-life and possible second-life applications of the LiB.

10. The method as claimed in claim 8, wherein the one or more operational KPIs comprises one or more of operating performance metrics and financial parameters agreed upon by the plurality of collaborators, wherein the one or more operational KPIs are tracked during operations.

11. The method as claimed in claim 1, wherein the one or more financial KPIs comprise one or more of timely and complete payments between the plurality of collaborators and estimates of residual value of the plurality of LiB assets at various future points in time.

12. The method as claimed in claim 1, wherein determining the composite performance score by the controller (202) comprises:
invoking a plurality of modules to process the data and meta-data collected from the plurality of technical units, prior to and during real-world operations;
updating information about the data, the corresponding metadata and processed data in a plurality of databases;
writing a hash of the updated plurality of databases on the BDL (118);
invoking one or more blockchain smart contract codes to calculate the one or more KPIs comprising technical, and operational and financial KPIs based on the processed data; and
invoking a blockchain smart contract that executes the composite performance score calculation based on current technical, and operational, and financial KPIs.

13. A system (100) for defining and assessing a composite performance score, in real-time and in an automated and trusted manner, the system comprising:
a plurality of LiB assets;
a plurality of collaborators associated with the plurality of LiB assets;
and a plurality of technical units associated with the plurality of LiB assets, wherein the plurality of technical units comprises:
a main server (102) comprising a memory (206), a controller (202), and an input-output interface (204), the memory comprising a plurality of modules and one or more databases;
a Blockchain Distributed Ledger, BDL, (118);
one or more telematics units, TU, (108) connected to the one or more assets with the plurality of LiB assets;
one or more Battery Management System, BMS, (110) connected to the plurality of LiB assets;
one or more Blockchain Oracles, BO, 122 connected to the one or more TUs (108), the BMS (110), and a plurality of servers, wherein the controller (202) is configured to:
generate one or more blockchain initial smart contract codes for monitoring and calculating one or more Key Performance Indicators (KPIs) and composite performance score agreed upon by the plurality of collaborators, prior to start of real-world operations;
perform an initial assessment of a current composite performance score, prior to the start of real-world operations, wherein the current composite performance score is calculated based on estimates of the one or more KPIs associated with the system (100) for one or more pre-defined operating patterns and environments for one or more of pre-defined time and charge-discharge cycles;
record the initial assessment of the one or more KPIs and the current composite performance score on a blockchain distributed ledger (BDL) (118);
collect periodically, data and corresponding metadata from the system (100);
store one or more of the collected data and hash of the collected data on the BDL (118);
calculate periodically, and update the one or more KPIs and the current composite performance score during the real-world operations by executing the one or more initial blockchain smart contract codes;
generate one or more revised blockchain smart contract codes for calculating of one or more revised KPIs and composite performance score, selected by the plurality of collaborators, during real-world operations of the system (100);
calculate the one or more revised KPIs and the current composite performance score using the data and the collected data stored in the memory (206) and the BDL (118); and
generate a report mapping the one or more KPIs and the composite performance score with the data on the BDL (118) used for the calculation of the one or more KPIs and the composite performance score, the one or more initial blockchain smart contract codes used in calculation of the one or more KPIs and the composite performance score, and an agreement agreed upon by the plurality of collaborators prior to the start of real-world operations.

14. The system as claimed in claim 13, wherein the data comprises one or more of technical data, operational data, and financial data collected during real-world operations.

15. The system as claimed in claim 13, wherein, for generating the one or more initial blockchain smart contract codes, the controller (202) is to:
establish connectivity amongst the plurality of technical units as required by the plurality of collaborators;
provide a user interface for the plurality of collaborators for defining the one or more KPIs to be measured and a method for calculating the one or more KPIs and the composite performance score;
generate the one or more initial blockchain smart contract codes based on a selection of the one or more KPIs and a method of calculating the one or more KPIs and the composite performance score, by the plurality of collaborators, and a state of agreement established by the plurality of collaborators, for each of selected KPIs and selected method of calculating the one or more KPIs and the composite performance score, upon authorization by the plurality of collaborators using a multisignature scheme; and
deploy the generated one or more initial blockchain smart contract codes on the BDL (118).

16. The system as claimed in claim 13, wherein the controller (202) is to perform the initial assessment of the current composite performance score, prior to the start of real-world operations and recording the initial assessment of the current composite performance score, on the BDL (118) by:
performing a plurality of tests on the plurality of LiB assets, for collecting test data comprising cell level test data and pack level test data;
collecting and analysing the test data and corresponding test metadata obtained from the plurality of tests and prior data and collecting and analysing estimates of operating patterns and operating environments that the plurality of LiB assets is subjected to during real-world operations and collecting and analysing estimates of financial and economic parameters that influence a residual value of the plurality of LiB assets over time;
storing plurality of data and one or more of results obtained from the plurality of tests and analyses and the hash of such data on the BDL (118) and a database in the memory (206);
calculating and recording one of one or more technical KPIs and the hash of the one or more technical KPIs on the BDL (118) and a database from a plurality of databases in the memory (206);
initializing one or more operational KPIs and one or more financial KPIs on the BDL (118); and
calculating an initial value of the current composite performance score based on the initial values of the one or more KPIs and recording the one or more KPIs and the current composite score on the BDL (118), wherein the one or more KPIs comprises the one or more technical KPIs, the one or more operational KPIs, and the one or more financial KPIs.

17. The system as claimed in claim 16, wherein the test data comprises the data from one or more of HPPC and DST tests, internal resistance and temperature tests, charging, discharging, tests at the cell, pack and vehicle levels, operating patterns and operating environments data comprising routes and speed patterns, elevation, wind speeds and directions, elevation, duty cycles, loading, ambient temperatures, and charging rates, financial and economic parameters comprising data related to predictions of future financial and economic factors comprising one or more of interest rates, loan terms and equity to debt ratios, exchange rates, cost of capital, future prices of LiBs, fuel prices, and energy prices, impacting future value of a used LiB asset from the plurality of LiB assets.

18. The system as claimed in claim 13, wherein, on generating the one or more revised blockchain smart contract codes, as selected by the plurality of collaborators, the controller (202) is to deploy the revised blockchain smart contract codes on the BDL (118) to replace one or more existing smart contracts on the BDL (118), during real-world operations, by updating a smart contract master registry.

19. The system as claimed in claim 18, wherein, the controller (202) is to deploy the revised blockchain smart contract codes on the BDL (118) by:
providing, by the controller (202), a user interface to the plurality of collaborators for selecting one or more of revised KPIs, and revised rules for replacing the one or more of the initial values of the one or more KPIs and initial rules;
reaching a state of agreement between the plurality of collaborators on one or more of revised KPIs and revised rules for calculating the one or more KPIs, using a multisignature scheme;
generating a smart contract for one or more of each updated KPI, the composite performance score, and the revised rules for calculating the one or more KPIs, and deploying the one or more generated smart contracts on the BDL; and
obtaining addresses of the one or more deployed revised blockchain smart contracts and replacing the addresses of the one or more existing smart contracts in the master registry, for updating the system (100) based on the agreement between the plurality of collaborators.

20. The system as claimed in claim 13, wherein the one or more KPIs comprises one or more technical KPIs, one or more operational KPIs, and one or more financial KPIs.

21. The system as claimed in claim 20, wherein the one or more technical KPIs comprises calculating one or more of residual capacity, internal resistance or power output of the plurality of LiB assets over various points in time or after varying numbers of charge-discharge cycles and over intended first-life and possible second-life applications of the LiB.

22. The system as claimed in claim 20, wherein the one or more operational KPIs comprises one or more of operating performance metrics and financial parameters agreed upon by the plurality of collaborators, wherein the one or more operational KPIs are tracked during operations.

23. The system as claimed in claim 20, wherein the one or more financial KPIs comprise one or more of timely and complete payments between the plurality of collaborators and estimates of residual value of the plurality of LiB assets at various future points in time.

24. The system as claimed in claim 13, wherein the controller (202) is to determine the composite performance score by:
invoking a plurality of modules to process the data and meta-data collected from the plurality of technical units, prior to and during real-world operations;
updating information about the data, the corresponding metadata, and processed data in a plurality of databases;
writing a hash of the updated plurality of databases on the BDL (118);
invoking one or more blockchain smart contract codes to calculate the one or more KPIs comprising technical, operational, and financial KPIs based on the processed data; and
invoking a blockchain smart contract that executes the composite performance score calculation based on current technical, operational, and financial KPIs.
